(19) United States
(12) Patent Application Publication
(10) Pub. No.: US 2023/0021541 A1
(43) Pub. Date: Jan. 26, 2023

(54) Combine, Grain Separation Method, Grain Separation System, Grain Separation Program, Recording Medium on Which Grain Separation Program Is Recorded, Grain Inspection Method, Grain Inspection System, Grain Inspection Program, and Recording Medium on Which Grain Inspection Program Is Recorded

(71) Applicant: Kubota Corporation, Osaka-shi (JP)

(72) Inventors: Shunsuke Edo, Sakai-shi (JP); Jun Adachi, Sakai-shi (JP); Yuki Oda, Sakai-shi (JP); Kaisei Inoue, Sakai-shi (JP); Takanori Hori, Sakai-shi (JP); Toshiaki Fujita, Sakai-shi (JP); Takehiro Nakanishi, Sakai-shi (JP)

(21) Appl. No.: 17/784,967

(22) PCT Filed: Oct. 28, 2020
(86) PCT No.: PCT/JP2020/040409

§ 371 Date: Jun. 13, 2022

(30) Foreign Application Priority Data
Dec. 26, 2019 (JP) 2019-237130
Dec. 26, 2019 (JP) 2019-237133
Dec. 26, 2019 (JP) 2019-237134

(51) Int. Cl. A01D 41/127

(52) U.S. Cl. CPC A01D 41/1275; A01D 41/1277

(57) ABSTRACT

A combine includes: a reaper to reap planted grain culms in a field; a threshing apparatus to thresh the reaped grain culms and separate the reaped grain culms into separated material containing normal grain and material to be discharged other than the separated material; a grain tank in which the separated material is storable; a conveying apparatus to convey the separated material from a separation section to the grain tank; a temporary storage section to take out and store some of the separated material that is being conveyed by the conveying apparatus; an image capture unit to capture an image of the separated material stored in the temporary storage section; and an image analysis module to analyze the image captured by the image capture unit, and perform distinguishing processing for distinguishing the normal grain in the separated material stored in the temporary storage section from foreign matter.

### CROSS-REFERENCE TO RELATED APPLICATIONS

This application is the United States national phase of International Application No. PCT/JP2020/040409 filed Oct. 28, 2020, and claims priority to Japanese Patent Application Nos. 2019-237130, 2019-237133, and 2019-237134 filed Dec. 26, 2019, the disclosures of which are hereby incorporated by reference in their entirety.

### BACKGROUND OF THE INVENTION

### Field of the Invention

The present invention relates to a technique pertaining to a combine that reaps planted grain culms in a field, and threshes and separates the reaped grain culms with use of a threshing apparatus.

The present invention also relates to a technique pertaining to a combine that includes a threshing unit for threshing reaped grain culms and a separation unit for separating grain from threshed material that is threshed by the threshing unit.

The present invention also relates to a technique pertaining to a combine that reaps planted grain culms in a field, and threshes and separates the reaped grain culms with use of a threshing apparatus.

### Description of Releated Art

1-1. Background Art [1]

A combine reaps planted grain culms, threshes and separates the reaped grain culms, conveys the obtained grain (separated material) to a grain tank, and stores the grain in the grain tank. Inappropriate threshing of grain culms may damage grain. Further, inappropriate separation may cause foreign matter other than grain, such as foreign substances, to be mixed in the separated material. This will result in inability to obtain grain with appropriate quality.

For example, a combine described in JP 2019-10075A (Patent Document 1) has a temporary storage section in a grain tank, and a camera for capturing an image of separated material stored in the temporary storage section, and adjusts various settings of a threshing apparatus or the like based on a grain separation accuracy (mixing of foreign matter, etc.) determined by analyzing a captured image.

1-2. Background Art [2]

A combine has conventionally been used that has a threshing unit for threshing grain culms reaped during travel, and a grain tank in which grain threshed by the threshing unit is storable. JP 2013-27340A (Patent Document 2) describes an example of this kind of combine.

The combine described in Patent Document 2 has, in a grain tank, a placement board on which grain is placeable, two light sources for emitting light toward two surfaces of the placement board, and an image capture unit for capturing a first image of grain on the placement board while light is being emitted from one of the two light sources, and a second image of grain on the placement board while light is being emitted from the other one of the two light sources. An image processing means extracts an image indicating foreign matter from the first image to calculate the amount of foreign matter, and calculates the quantity of damaged unhulled grain and the quantity of rachis branches from the second image.

1-3. Background Art [3]

A combine also reaps planted grain culms, threshes and separates the reaped grain culms, conveys the obtained grain (separated material) to a grain tank, and stores the grain therein. Inappropriate threshing of grain culms may damage grain. Further, inappropriate separation may cause foreign matter other than grain, such as foreign substances, to be mixed in the separated material. This will result in inability to obtain grain with appropriate quality.

For example, the combine described in Patent Document 2 has an inspection device having a camera in the grain tank, captures an image of separated material conveyed to the grain tank with use of the camera, and adjusts settings of chaff sieves, dust feed valves, or the like of the threshing apparatus based on a grain separation accuracy (mixing of foreign matter, etc.) determined by analyzing the captured images.

### PATENT DOCUMENTS

Patent Document 1: JP 2019-10075A
Patent Document 2: JP 2013-27340A

In the combine described in Patent Document 1, separated material conveyed to the grain tank by a conveying apparatus and thrown into the storage section are stored in the temporary storage section, which is supported at a rear part (a position distant from a thrower) of the grain tank. Therefore, it takes time for separated material to be accumulated in the temporary storage section, and the timing of checking the separation accuracy and quality of the separated material is highly likely to be delayed. As a result, for example, it may take time to reflect the analysis results in control of the body of the combine, resulting in a delay in reaction in the control.

Therefore, a technique for checking the separation accuracy and quality of separated material at an early stage is needed.

In the technique described in Patent Document 2, the aforementioned inspection device for calculating the amount of foreign matter, the quantity of damaged unhulled grain, and the quantity of rachis branches is located in an inclined face between a bottom face and a side face within the grain tank. For this reason, it takes time from when a threshing process and a grain separation process are performed to when inspection is performed, and the inspection cannot be quickly performed after the separation process. Moreover, in the technique described in Patent Document 2, the inspection device is located in the inclined face on the bottom side in the grain tank. There is therefore a concern that the inspection cannot be appropriately performed depending on the amount of grain stored in the grain tank. Furthermore, since the inspection is performed within a branching path that branches in the grain tank, the inspection may not be able to be appropriately performed depending also on the degree of scattering of foreign matter, damaged unhulled grain, and rachis branches.

There is therefore a need for a technique that enables grain to be quickly and appropriately inspected during grain harvesting.

The invention described in Patent Document 2 includes a narrow and elongated guiding path that partially overlaps a lower part of a throwing opening of the grain tank and extends downward along a side wall of the grain tank, and the inspection device that is located on the extension of the guiding path and has an inclined face and a camera arranged below the inclined face, and is configured to reliably receive some grain released from the throwing opening directly in the guiding path and capture, with use of the camera, images of grain that is guided downward by the guiding path and slides down on the inclined face of the inspection device. Therefore, with the invention described in Patent Document 2, a mass of grain slides down along the guiding path. If, for example, a large amount of grain is conveyed, foreign matter other than normal grain may be buried in the normal grain, which may degrade the detection accuracy.

There is therefore a need for a technique capable of improving the accuracy of detecting the separation state of the threshing apparatus.

### SUMMARY OF THE INVENTION

A combine according to an embodiment of the present invention includes: a reaper configured to reap planted grain culms in a field; a threshing apparatus configured to thresh the reaped grain culms and separate the reaped grain culms into separated material containing normal grain and material to be discharged other than the separated material; a grain tank in which the separated material is storable; a conveying apparatus configured to convey the separated material from the threshing apparatus to the grain tank; a temporary storage section configured to take out and store some of the separated material that is being conveyed by the conveying apparatus; an image capture unit configured to capture an image of the separated material stored in the temporary storage section; and an image analysis module configured to analyze the image captured by the image capture unit and perform distinguishing processing for distinguishing the normal grain in the separated material stored in the temporary storage section from foreign matter other than the normal grain, the foreign matter being mixed in the separated material.

This configuration makes it possible to capture an image of separated material that is being conveyed to the grain tank after the separation. Thus, foreign matter contained in the separated material can be detected at an early stage after the separation. That is, the separation accuracy and quality of the separated material can be checked earlier.

In the present invention, it is preferable that the separated material whose image has been captured by the image capture unit is returned to a conveying path of the conveying apparatus.

With this configuration, the separated material whose image has been captured can be collected without unnecessary motion. Further, grain can be conveyed to the grain tank with use of the conveying apparatus, compared to the case of directly conveying grain to the grain tank. It is therefore not necessary to provide a dedicated return path or return mechanism.

In the present invention, it is preferable that the conveying path includes a feeding path through which the separated material is conveyable and a return path in which the separated material is no longer conveyed, and the separated material whose image has been captured by the image capture unit is returned to the return path.

With this configuration, separated material whose image has been captured does not affect the conveying apparatus conveying separated material, compared to the case where separated material is returned to a feeding path. Therefore, the conveyance is less likely to be interrupted.

In the present invention, it is preferable that the temporary storage section has a lid portion that is openable and closable and constitutes an upper face of the temporary storage section, and a bottom portion that is openable and closable and constitutes a bottom face of the temporary storage section, the separated material is stored in the temporary storage section as a result of the lid portion being opened and the bottom portion being closed, and the separated material whose image has been captured by the image capture unit is discharged from the temporary storage section as a result of the bottom portion being opened.

This configuration enables separated material to be temporarily stored by simply controlling the lid portion and the bottom portion. In addition, the time taken for separated material to flow into the temporary storage section can be adjusted with use of the lid portion, and the time taken for the separated material to be released from the temporary storage section can be adjusted with use of the bottom portion.

In the present invention, it is preferable that the image capture unit captures an image of the separated material in an image capture-ready state where the lid portion is closed and the bottom portion is closed.

If an image of separated material is captured with the lid portion open, there are cases where flowing separated material comes between the image capture unit and stored separated material whose image is to be captured, and the separated material whose image is to be captured is hidden behind the flowing separated material, resulting in a decline in the image capture accuracy. This configuration makes it possible to capture an image of only the stored separated material whose image is to be captured, with no flowing separated material, thus improving the accuracy of capturing an image of the separated material.

In the present invention, it is preferable that the combine further includes: a link linked to the lid portion and the bottom portion such that the lid portion and the bottom portion move in conjunction with the link; and an actuator configured to operate the link, the link being operated by the actuator switches the temporary storage section between a storing state where the lid portion is open and the bottom portion is closed such that the separated material is stored in the temporary storage section, and a discharging state where the lid portion is closed and the bottom portion is open such that the stored separated material is discharged, and the image capture-ready state emerges during transition from the storing state to the discharging state.

With this configuration, the link enables the lid portion and the bottom portion to be opened and closed with use of one actuator. As a result, a repetition cycle of storage in the temporary storage section, image capture, and discharge from the temporary storage section can be implemented by a simple operation of the aforementioned simple mechanism, without unnecessary motion.

In the present invention, it is preferable that the lid portion partially constitutes a lower part of a conveying path of the conveying apparatus.

In this configuration, the lid portion is located in a lower part of the conveying path. Therefore, simply opening the lid portion causes separated material to easily flow into the temporary storage section due to free fall.

In the present invention, it is preferable that the combine has a neural network trained by machine learning, the neural network being stored in the combine, and the image analysis module performs the distinguishing processing by inputting the image captured by the image capture unit to the neural network.

With this configuration, image analysis can be implemented with a more accurate and simple method by analyzing images using AI (artificial intelligence).

In the present invention, it is preferable that the machine learning is performed by using, as input data, a plurality of the images captured by the image capture unit, and using, as training data, information indicating whether or not each of the plurality of images is an image of the foreign matter.

This configuration enables generation of simple and highly accurate learned data.

In the present invention, it is preferable that the foreign matter includes at least one of a foreign substance, damaged grain, dirty grain, a rachis branch, and bran.

This configuration enables acquisition of detailed information regarding foreign matter.

A grain separation method according to the present invention includes: a reaping step of reaping planted grain culms in a field; a threshing step of threshing the reaped grain culms and separating the reaped grain culms into separated material containing normal grain and material to be discharged other than the separated material, with use of a threshing apparatus; a storing step of storing the separated material in a grain tank; a conveying step of conveying the separated material from the threshing apparatus to the grain tank, with use of a conveying apparatus; a temporary storage step of taking out some of the separated material that is being conveyed by the conveying apparatus and storing the taken-out separated material in a temporary storage section; an image capture step of capturing an image of the separated material stored in the temporary storage section, with use of an image capture unit; and an image analysis step of analyzing the image captured by the image capture unit, and performing distinguishing processing for distinguishing the normal grain in the separated material stored in the temporary storage section from foreign matter other than the normal grain, the foreign matter being mixed in the separated material.

This grain separation method also enables the separation accuracy and quality of separated material to be checked at an early stage.

A grain separation system according to the present invention includes: a reaper configured to reap planted grain culms in a field; a threshing apparatus configured to thresh the reaped grain culms and separate the reaped grain culms into separated material containing normal grain and material to be discharged other than the separated material; a grain tank in which the separated material is storable; a conveying apparatus configured to convey the separated material from the threshing apparatus to the grain tank; a temporary storage section configured to take out and store some of the separated material that is being conveyed by the conveying apparatus; an image capture unit configured to capture an image of the separated material stored in the temporary storage section; and an image analysis module configured to analyze the image captured by the image capture unit and perform distinguishing processing for distinguishing the normal grain in the separated material stored in the temporary storage section from foreign matter other than the normal grain, the foreign matter being mixed in the separated material.

This grain separation system also enables the separation accuracy and quality of separated material to be checked at an early stage.

A grain separation program according to the present invention causes a computer to execute: a reaping function of reaping planted grain culms in a field; a threshing function of threshing the reaped grain culms and separating the reaped grain culms into separated material containing normal grain and material to be discharged other than the separated material, with use of a threshing apparatus; a storing function of storing the separated material in a grain tank; a conveying function of conveying the separated material from the threshing apparatus to the grain tank, with use of a conveying apparatus; a temporary storage function of taking out some of the separated material that is being conveyed by the conveying apparatus and storing the taken-out separated material in a temporary storage section; an image capture function of capturing an image of the separated material stored in the temporary storage section, with use of an image capture unit; and an image analysis function of analyzing the image captured by the image capture unit, and performing distinguishing processing for distinguishing the normal grain in the separated material stored in the temporary storage section from foreign matter other than the normal grain, the foreign matter being mixed in the separated material.

The separation accuracy and quality of separated material can be checked at an early stage by causing a computer to execute this grain separation program installed therein.

A recording medium on which a grain separation program is recorded according to the present invention is a recording medium on which a grain separation program is recorded, the program causing a computer to execute: a reaping function of reaping planted grain culms in a field; a threshing function of threshing the reaped grain culms and separating the reaped grain culms into separated material containing normal grain and material to be discharged other than the separated material, with use of a threshing apparatus; a storing function of storing the separated material in a grain tank; a conveying function of conveying the separated material from the threshing apparatus to the grain tank, with use of a conveying apparatus; a temporary storage function of taking out some of the separated material that is being conveyed by the conveying apparatus and storing the taken-out separated material in a temporary storage section; an image capture function of capturing an image of the separated material stored in the temporary storage section, with use of an image capture unit; and an image analysis function of analyzing the image captured by the image capture unit, and performing distinguishing processing for distinguishing the normal grain in the separated material stored in the temporary storage section from foreign matter other than the normal grain, the foreign matter being mixed in the separated material.

The separation accuracy and quality of separated material can be checked at an early stage by installing the grain separation program in a computer via this recording medium and causing the computer to implement the program.

A characteristic configuration of a combine according to the present invention lies in that the combine includes: a threshing unit configured to thresh reaped grain culms and discharge threshed material; a separation unit configured to separate grain as separated material from the discharged threshed material; a grain tank in which the separated material conveyed thereto is storable; an image capture unit configured to acquire a captured image by capturing an image of an inside of a conveying path through which the separated material is conveyable from the separation unit to the grain tank; and a distinguishing unit configured to distinguish, by means of image analysis, separated material included in the captured image into normal grain that meets a predetermined quality and foreign matter other than the normal grain, the foreign matter being mixed in the separated material.

With this characteristic configuration, normal grain and foreign matter can be separated from each other while threshed material is being conveyed from the separation unit to the grain tank. Accordingly, grain can be inspected quickly and appropriately during grain harvesting.

It is preferable that the combine further includes a calculation unit configured to calculate a ratio between the normal grain and the foreign matter in the separated material included in the captured image, based on a result of the distinction by the distinguishing unit.

This configuration enables an operator to easily understand the ratio between normal grain and foreign matter stored in the grain tank.

It is preferable that the combine further includes a parameter change unit configured to change a threshing parameter with which a threshing capability of the threshing unit is settable and a separation parameter with which a separation capability of the separation unit is settable, in accordance with the ratio between the normal grain and the foreign matter.

With this configuration, if, for example, the ratio between normal grain and foreign matter does not take an expected value, the ratio between normal grain and foreign matter can be brought closer to the expected value by changing the operation state of the threshing unit and/or separation unit.

It is preferable that the distinguishing unit performs distinction by inputting image data generated based on the captured image, to a neural network trained to distinguish the normal grain in the separated material.

This configuration enables an increase in the distinction accuracy. Accordingly, grain can be inspected more appropriately.

It is preferable that the neural network is trained to output a distinction result indicating that the separated material contains the normal grain if image data for training generated based on a captured image including the normal grain is input as training data, and is trained to output a distinction result indicating that the separated material contains the foreign matter if image data for training generated based on a captured image including the foreign matter is input as training data.

This configuration enables the neural network of the distinguishing unit to be trained in a manner appropriate for grain distinction.

A grain inspection method according to the present invention includes: a threshing step of threshing reaped grain culms and discharging threshed material from a threshing unit; a separation step of separating grain as separated material from the discharged threshed material, with use of a separation unit; a storing step of storing, in a grain tank, the separated material conveyed thereto; an image capture step of acquiring a captured image by capturing an image of an inside of a conveying path through which the separated material is conveyable from the separation unit to the grain tank; and a distinction step of distinguishing, by means of image analysis, separated material included in the captured image into normal grain that meets a predetermined quality and foreign matter other than the normal grain, the foreign matter being mixed in the separated material.

This grain inspection method also enables grain to be inspected quickly and appropriately during grain harvesting.

A grain inspection system according to the present invention includes: a threshing unit configured to thresh reaped grain culms and discharge threshed material; a separation unit configured to separate grain as separated material from the discharged threshed material; a grain tank in which the separated material conveyed thereto is storable; an image capture unit configured to acquire a captured image by capturing an image of an inside of a conveying path through which the separated material is conveyable from the separation unit to the grain tank; and a distinguishing unit configured to distinguish, by means of image analysis, separated material included in the captured image into normal grain that meets a predetermined quality and foreign matter other than the normal grain, the foreign matter being mixed in the separated material.

This grain inspection system also enables grain to be inspected quickly and appropriately during grain harvesting.

A grain inspection program according to the present invention causes a computer to execute: a threshing function of threshing reaped grain culms and discharging threshed material from a threshing unit; a separation function of separating grain as separated material from the discharged threshed material, with use of a separation unit; a storing function of storing, in a grain tank, the separated material conveyed thereto; an image capture function of acquiring a captured image by capturing an image of an inside of a conveying path through which the separated material is conveyable from the separation unit to the grain tank; and a distinction function of distinguishing, by means of image analysis, separated material included in the captured image into normal grain that meets a predetermined quality and foreign matter other than the normal grain, the foreign matter being mixed in the separated material.

Grain can be inspected quickly and appropriately during grain harvesting by causing a computer to execute this grain inspection program installed therein.

A recording medium on which a grain inspection program is recorded according to the present invention is a recording medium on which a grain inspection program is recorded, the program causing a computer to execute: a threshing function of threshing reaped grain culms and discharging threshed material from a threshing unit; a separation function of separating grain as separated material from the discharged threshed material, with use of a separation unit; a storing function of storing, in a grain tank, the separated material conveyed thereto; an image capture function of acquiring a captured image by capturing an image of an inside of a conveying path through which the separated material is conveyable from the separation unit to the grain tank; and a distinction function of distinguishing, by means of image analysis, separated material included in the captured image into normal grain that meets a predetermined quality and foreign matter other than the normal grain, the foreign matter being mixed in the separated material.

Grain can be inspected quickly and appropriately during grain harvesting by installing the grain separation program in a computer via this recording medium and causing the computer to implement the program.

A combine according to an embodiment of the present invention includes: a reaper configured to reap planted grain culms in a field; a threshing apparatus configured to thresh the reaped grain culms and separate the reaped grain culms into separated material containing normal grain and material to be discharged other than the separated material; a grain tank in which the separated material is storable; a conveying apparatus configured to convey the separated material from the threshing apparatus to the grain tank; an inclined section having a surface on which at least some of the separated material before being stored in the grain tank is passable; an image capture unit configured to capture an image of the separated material passing through the inclined section; and an image analysis module configured to analyze the image captured by the image capture unit and perform distinguishing processing for distinguishing normal grain in the separated material passing through the inclined section from foreign matter other than the normal grain, the foreign matter being mixed in the separated material, wherein the conveying apparatus includes a grain releasing device configured to throw the separated material into the grain tank, and the inclined section is located within the grain tank in such a manner as to receive the separated material thrown from the grain releasing device.

The present invention causes separated material to scatter within the grain tank while being widely distributed by being thrown by the grain releasing device. The separated material thus slides down on the inclined section in a dispersed manner. Accordingly, foreign matter is unlikely to be buried in normal grain, and an image of separated material in a stable state sliding down on the inclined section can be captured thoroughly and reliably. For this reason, the present invention improves the accuracy of detecting the separation state of the threshing apparatus.

In the present invention, it is preferable that the image capture unit is located within the grain tank and faces the inclined section.

Dust flies in the grain tank while separated material is being thrown into the grain tank. That is, the dust causes diffuse reflection of light, which is a very difficult image capture condition. However, with the present invention, the image capture unit faces the inclined section (from the direct front or from the substantially direct front). Therefore, the optical axis of the image capture unit intersects the inclined section perpendicularly or substantially perpendicularly, and an image of separated material can be captured in a state where the image capture is hardly affected by diffuse reflection caused by dust existing between the image capture unit and the inclined section. Accordingly, the separation system in the threshing apparatus can be accurately checked.

In the present invention, it is preferable that the image capture unit is located between the grain releasing device and the inclined section, with a back of the image capture unit facing the grain releasing device, and the grain releasing device throws the separated material such that the thrown separated material flies over the image capture unit and falls onto the inclined section.

If thrown separated material further falls from the front onto separated material sliding down on the inclined section while the image capture unit is capturing an image, the image capture timing is limited by the disturbed flowing state. Therefore, the image capture unit is required to have a high image capture capability. However, in the present invention, the image capture unit has its back to the grain releasing device. Therefore, the image capture unit serves as a wall, and thrown separated material is less likely to fall from the front onto separated material flowing down on the inclined section. As a result, separated material falls onto the inclined section only from above, and the flowing state of the separated material sliding down on the inclined section is less likely to be disturbed. The number of favorable image capture timings increases, eliminating the need for excessively increasing the image capture capability of the image capture unit and suppressing an increase in the cost.

In the present invention, it is preferable that the inclined section is made of a permeable material, and the image capture unit is located in a back-face region of the inclined section with respect to the surface thereof on which the separated material is passable.

Dust flies in the grain tank while separated material is being thrown into the grain tank. That is, the dust causes diffuse reflection of light, which is a very difficult image capture condition. However, with the present invention, a clear image of separated material can be captured, without being affected by dust, by capturing the image while in intimate contact with the inclined section from the back side of the inclined section. As a result, the separation system in the threshing apparatus can be accurately checked.

In the present invention, it is preferable that the combine further includes a full sensor configured to come into contact with the separated material stored in the grain tank and detect that the grain tank is filled with the separated stored material, the full sensor being located in an upper part of an inside of the grain tank, wherein the inclined section and the image capture unit are located at positions higher than the full sensor.

With this configuration, the inclined section and the image capture unit are not buried in separated material before the grain tank becomes full. It is therefore possible to captures images with use of the image capture unit for as long as possible, and to increase the number of times that the image capture unit captures the images.

In the present invention, it is preferable that the combine has a neural network trained by machine learning, the neural network being stored in the combine, and the image analysis module performs the distinguishing processing by inputting the image captured by the image capture unit to the neural network.

Image analysis can be implemented with a more accurate and simple method by thus analyzing images using AI (artificial intelligence).

In the present invention, it is preferable that the machine learning is performed by using, as input data, a plurality of the images captured by the image capture unit, and using, as training data, information indicating whether or not each of the plurality of images is an image of the foreign matter.

This configuration enables generation of simple and highly accurate learned data.

In the present invention, it is preferable that the foreign matter includes at least one of a foreign substance, damaged grain, dirty grain, a rachis branch, and bran.

This configuration enables acquisition of detailed information regarding foreign matter.

A grain separation method according to the present invention includes: a reaping step of reaping planted grain culms in a field; a threshing step of threshing the reaped grain culms and separating the reaped grain culms into separated material containing normal grain and material to be discharged other than the separated material, with use of a threshing apparatus; a storing step of storing the separated material in a grain tank; a conveying step of conveying the separated material from the threshing apparatus to the grain tank, with use of a conveying apparatus; an inclined section passage step of causing at least some of the separated material before being stored in the grain tank to pass on a surface of an inclined section; an image capture step of capturing an image of the separated material passing on the inclined section, with use of an image capture unit; an image analysis step of analyzing the image captured by the image capture unit, and performing distinguishing processing for distinguishing normal grain in the separated material passing through the inclined section from foreign matter other than the normal grain, the foreign matter being mixed in the separated material; and a grain releasing step of throwing the separated material conveyed by the conveying apparatus into the grain tank, with use of a grain releasing device, wherein in the inclined section passage step, the separated material thrown from the grain releasing device is received within the grain tank.

This grain separation method also makes it possible to improve the accuracy of detecting the separation state of the threshing apparatus.

A grain separation system according to the present invention includes: a reaper configured to reap planted grain culms in a field; a threshing apparatus configured to thresh the reaped grain culms and separate the reaped grain culms into separated material containing normal grain and material to be discharged other than the separated material; a grain tank in which the separated material is storable; a conveying apparatus configured to convey the separated material from the threshing apparatus to the grain tank; an inclined section having a surface on which at least some of the separated material before being stored in the grain tank is passable; an image capture unit configured to capture an image of the separated material passing through the inclined section; and an image analysis module configured to analyze the image captured by the image capture unit and perform distinguishing processing for distinguishing normal grain in the separated material passing through the inclined section from foreign matter other than the normal grain, the foreign matter being mixed in the separated material, wherein the conveying apparatus includes a grain releasing device configured to throw the separated material into the grain tank, and the inclined section is located within the grain tank in such a manner as to receive the separated material thrown from the grain releasing device.

This grain separation system also makes it possible to improve the accuracy of detecting the separation state of the threshing apparatus.

A grain separation program according to the present invention causes a computer to execute: a reaping function of reaping planted grain culms in a field; a threshing function of threshing the reaped grain culms and separating the reaped grain culms into separated material containing normal grain and material to be discharged other than the separated material, with use of a threshing apparatus; a storing function of storing the separated material in a grain tank; a conveying function of conveying the separated material from the threshing apparatus to the grain tank, with use of a conveying apparatus; an inclined section passage function of causing at least some of the separated material before being stored in the grain tank to pass on a surface of an inclined section; an image capture function of capturing an image of the separated material passing on the inclined section, with use of an image capture unit; an image analysis function of analyzing the image captured by the image capture unit, and performing distinguishing processing for distinguishing normal grain in the separated material passing through the inclined section from foreign matter other than the normal grain, the foreign matter being mixed in the separated material; and a grain releasing function of throwing the separated material conveyed by the conveying apparatus into the grain tank, with use of a grain releasing device, wherein in the inclined section passage function, the separated material thrown from the grain releasing device is received within the grain tank.

The accuracy of detecting the separation state of the threshing apparatus can be improved by causing a computer to execute this grain separation program installed therein.

A recording medium on which a grain separation program is recorded according to the present invention is a recording medium on which a grain separation program is recorded, the program causing a computer to execute: a reaping function of reaping planted grain culms in a field; a threshing function of threshing the reaped grain culms and separating the reaped grain culms into separated material containing normal grain and material to be discharged other than the separated material, with use of a threshing apparatus; a storing function of storing the separated material in a grain tank; a conveying function of conveying the separated material from the threshing apparatus to the grain tank, with use of a conveying apparatus; an inclined section passage function of causing at least some of the separated material before being stored in the grain tank to pass on a surface of an inclined section; an image capture function of capturing an image of the separated material passing on the inclined section, with use of an image capture unit; an image analysis function of analyzing the image captured by the image capture unit, and performing distinguishing processing for distinguishing normal grain in the separated material passing through the inclined section from foreign matter other than the normal grain, the foreign matter being mixed in the separated material; and a grain releasing function of throwing the separated material conveyed by the conveying apparatus into the grain tank, with use of a grain releasing device, wherein in the inclined section passage function, the separated material thrown from the grain releasing device is received within the grain tank.

The accuracy of detecting the separation state of the threshing apparatus can be improved by installing the grain separation program in a computer via this recording medium and causing the computer to implement the program.

### BRIEF DESCRIPTION OF THE DRAWINGS

FIG. 1 is an overall right side view of a combine according to a first embodiment.

FIG. 2 is an overall plan view of the combine according to the first embodiment.

FIG. 3 is a vertical cross-sectional view, as viewed from the left side, of a threshing apparatus according to the first embodiment.

FIG. 4 is a front view of a grain tank, a grain elevator, and the threshing apparatus according to the first embodiment.

FIG. 5 is a vertical cross-sectional view, as viewed from the right side, of the grain elevator and a grain distinguishing device according to the first embodiment.

FIG. 6 is an enlarged vertical cross-sectional view, as viewed from the right side, of the grain distinguishing device in an image capture-ready state according to the first embodiment.

FIG. 7 is an enlarged vertical cross-sectional view, as viewed from the right side, of the grain distinguishing device in a storage-ready state according to the first embodiment.

FIG. 8 is an enlarged vertical cross-sectional view, as viewed from the right side, of the grain distinguishing device in a discharge-ready state according to the first embodiment.

FIG. 9 is a block diagram illustrating a configuration for distinguishing grain according to the first embodiment.

FIG. 10 is a side view of a combine according to a second embodiment.

FIG. 11 is a plan view of the combine according to the second embodiment.

FIG. 12 is a vertical cross-sectional view of a threshing apparatus of the combine according to the second embodiment.

FIG. 13 is a block diagram showing functional parts that perform processing associated with distinction according to the second embodiment.

FIG. 14 shows an example of a captured image and a marking according to the second embodiment.

FIG. 15 is an overall right side view of a combine according to a third embodiment.

FIG. 16 is an overall plan view of the combine according to the third embodiment.

FIG. 17 is a vertical cross-section view, as viewed from the left side, of a threshing apparatus according to the third embodiment.

FIG. 18 is an enlarged vertical cross-sectional view, as viewed from the right side, of a grain tank for illustrating a configuration of a grain distinguishing device according to the third embodiment.

FIG. 19 is an enlarged horizontal cross-sectional view, as viewed from above, of the grain tank for illustrating an arrangement of the grain distinguishing device according to the third embodiment.

FIG. 20 is an enlarged vertical cross-sectional view, as viewed from the rear side, of the grain tank for illustrating a configuration of the grain distinguishing device according to the third embodiment.

FIG. 21 is a block diagram illustrating a configuration for distinguishing grain according to the third embodiment.

### DESCRIPTION OF THE INVENTION

### First Embodiment

### Overall Configuration of Combine

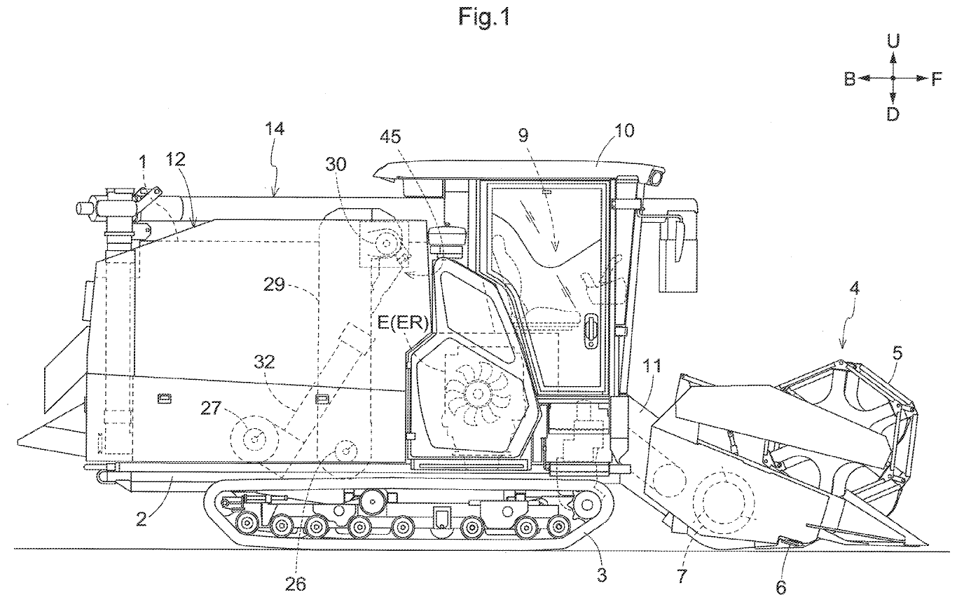

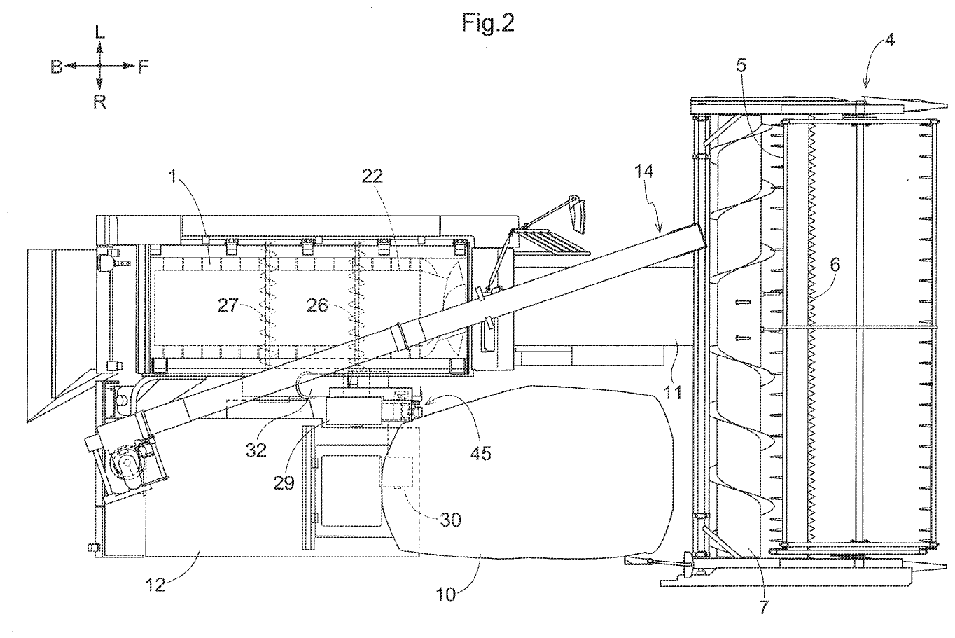

First, a schematic configuration of a combine according to the present embodiment will be described with reference to FIGS. 1 and 2. The following description will take a normal combine as an example of the combine.

In the present embodiment, “front” (the direction of F arrow in FIG. 1) means the front in the front-back direction (travel direction) of the body of the combine, and “back” (the direction of B arrow in FIG. 1) means the back in the front-back direction of the body of the combine to facilitate understanding, unless stated otherwise. “Upper/above” (the direction of U arrow in FIG. 1) and “lower/below” (the direction of D arrow in FIG. 1) refer to positional relationships in the vertical direction of the body of the combine, and indicate relationships in terms of the ground height. The “left-right direction” and the “lateral direction” mean the transverse direction of the body of the combine (widthwise direction of the body of the combine) perpendicular to the front-back direction of the body of the combine. In other words, “left” (the direction of L arrow in FIG. 2) and “right” (the direction of arrow R in FIG. 2) respectively mean the leftward and rightward directions of the body of the combine.

The combine has crawler traveling devices 3, a body frame 2 supported by the traveling devices 3, a reaper 4 for reaping a crop (any of various crops such as rice, wheat, soybean, and rapeseed) in a field, a feeder 11, a threshing apparatus 1, a grain tank 12, and a grain unloader 14.

The reaper 4 includes a raking reel 5 for raking the crop, a clipper-type cutter 6 for cutting the crop in the field, and an auger 7 for horizontally feeding the reaped crop to the feeder 11. The crop reaped by the reaper 4 is conveyed to the threshing apparatus 1 by the feeder 11, and threshed and separated by the threshing apparatus 1. The separated material that has been threshed and separated by the threshing apparatus 1 is stored in the grain tank 12, and is discharged, as appropriate, to the outside of the combine by the grain unloader 14.

The combine has a cab 9 located on the right rear of the reaper 4 and adjacent to the feeder 11. The cab 9 is covered by a cabin 10. The combine has an engine compartment ER below the cab 9. The engine compartment ER accommodates an engine E, as well as a cooling fan, a radiator, and the like, which are not particularly shown in the figure. Motive power of the engine E is transmitted to work machines, such as the traveling devices 3, the reaper 4, and the threshing apparatus 1, by a motive power transmission mechanism (not shown).

Threshing Apparatus

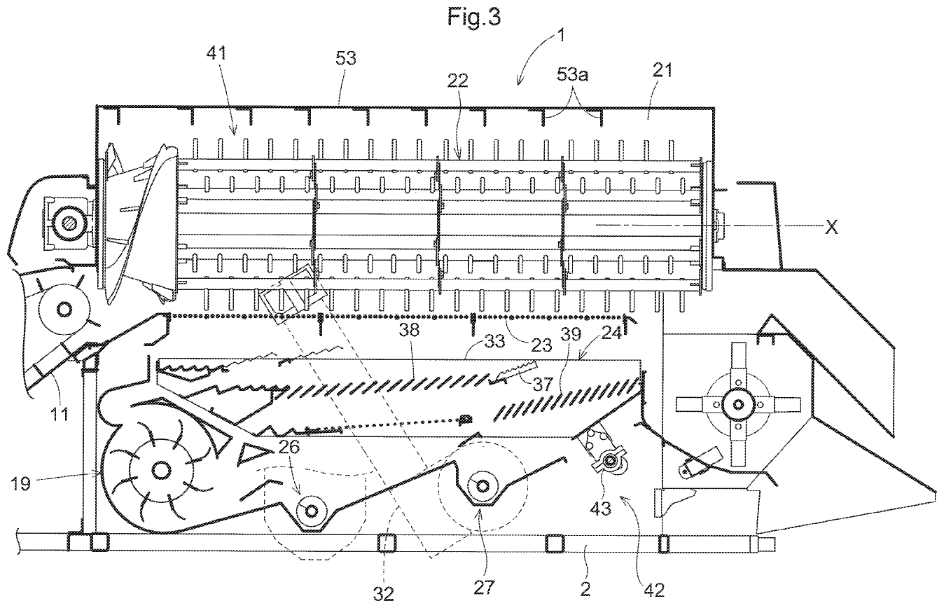

Next, a configuration of the threshing apparatus 1 will be described with reference to FIG. 3. The threshing apparatus 1 includes a threshing section 41 for threshing the crop with use of a threshing cylinder 22, and a separation section 42 for shaking and separating threshed material. The threshing section 41 is arranged in an upper region of the threshing apparatus 1. A receiving net 23 is located below the threshing section 41. The separation section 42 is located below the receiving net 23. The separation section 42 separates threshed material leaking down from the receiving net 23 into separated material that contains grain to be collected, and material to be discharged, such as waste straw.

The threshing section 41 has a threshing chamber 21 surrounded by left and right side walls, a top plate 53, and the receiving net 23 of the threshing apparatus 1. The threshing chamber 21 includes the threshing cylinder 22 that rotates to thresh the crop, and a plurality of dust feed valves 53a. The crop conveyed by the feeder 11 is put into the threshing chamber 21 and threshed by the threshing cylinder 22. The crop rotated together with the threshing cylinder 22 is transferred backward by a feeding effect of the dust feed valves 53a.

The dust feed valves 53a each have a plate shape, and are located on an inner face (lower face) of the top plate 53 at predetermined spacing in the front-back direction. The dust feed valves 53a are inclined with respect to a rotation axis X in a plan view. For this reason, each dust feed valve 53a exerts a force that moves backward the reaped grain culms rotating together with the threshing cylinder 22 in the threshing chamber 21. The inclination angle of the dust feed valves 53a with respect to the rotation axis X is adjustable. The speed of feeding the crop backward in the threshing cylinder 22 is determined by the inclination angle of the dust feed valves 53a. The threshing efficiency of threshing the crop is also affected by the speed of feeding the crop in the threshing cylinder 22. As a result, the processing capability for threshing the crop is adjustable with various means, which include changing of the inclination angle of the dust feed valves 53a. Although not specifically shown in the figure, a dust feed valve control mechanism capable of changing the inclination of the dust feed valves 53a is provided such that the inclination angle of the dust feed valves 53a is automatically adjustable.

The separation section 42 includes a shaking separator 24 having a sieve case 33, a winnower 19, a primary-material collecting section 26, a secondary-material collecting section 27, and a secondary-material returner 32.

The winnower 19 is located in a front lower region of the separation section 42, and generates a rearward separation wind from the front side of the shaking separator 24 in the direction in which processed material is conveyed. The separation wind has an effect of feeding relatively lightweight waste straw or the like toward the back of the sieve case 33. In the shaking separator 24, threshed material in the sieve case 33 is shaken and separated while being transferred backward due to a shake-drive mechanism 43 shaking the sieve case 33. For this reason, the upstream side of the shaking separator 24 in the direction in which processed material is conveyed will be referred to as a front end or a front side, and the downstream side will be referred to as a rear end or rear side in the following description. Note that the intensity (air volume, wind speed) of the separation wind of the winnower 19 is changeable. A stronger separation wind facilitates the backward feeding of threshed material and increases the separation speed. Conversely, a weaker separation wind makes threshed material stay longer in the sieve case 33 and increases the separation accuracy. It is therefore possible to adjust the separation efficiency (separation accuracy and separation speed) of the shaking separator 24 by changing the intensity of the separation wind of the winnower 19. Although not specifically shown in the figure, a winnower control mechanism capable of changing the intensity of the separation wind of the winnower 19 is provided such that the intensity of the separation wind of the winnower 19 is automatically changeable.

The sieve case 33 has a first chaff sieve 38 in the front half, and a second chaff sieve 39 in the rear half. In addition to the first chaff sieve 38 and so on, the sieve case 33 also has a grain pan and a grain sieve, which are general components and are therefore not specifically described. Threshed material leaking down from the receiving net 23 falls onto the first chaff sieve 38 and the second chaff sieve 39. Most of the threshed material leaks down from the receiving net 23 to the front half of the sieve case 33 including the first chaff sieve 38, and is separated, first roughly and then accurately, by the front half of the sieve case 33. Some of the threshed material leaks down from the receiving net 23 to the second chaff sieve 39, or does not leak down to the first chaff sieve 38 but is transferred to the second chaff sieve 39, and is separated by the second chaff sieve 39.

The primary-material collecting section 26 having a screw is located below the front half of the sieve case 33, and the secondary-material collecting section 27 having a screw is located below the rear half of the sieve case 33. Primary material (“separated material” in the present invention) that has been separated and has leaked down in the front half of the sieve case 33 is collected by the primary-material collecting section 26 and conveyed toward the grain tank 12 (rightward in the left-right direction of the body of the combine). Secondary material (which is generally separated with low accuracy and contains a high proportion of cut straw or the like) that has been separated and has leaked down in the rear half (second chaff sieve 39) of the sieve case 33 is collected by the secondary-material collecting section 27. The secondary material collected by the secondary-material collecting section 27 is returned to the front part of the separation section 42 by the secondary-material returner 32 and re-separated by the sieve case 33.

The first chaff sieve 38 includes a plurality of plate-like chaff lips arranged in the transfer direction (front-back direction). Each chaff lip is inclined with its rear end raised obliquely upward. The inclination angle of the chaff lips is variable. The steeper the inclination angle is, the wider the spacing between adjacent chaff lips is, and the more easily threshed material leaks down. For this reason, the separation efficiency (separation accuracy and separation speed) of the shaking separator 24 is adjustable by adjusting the inclination angle of the chaff lips. A lip control mechanism capable of changing the inclination of the chaff lips is provided such that the inclination angle of the chaff lips is automatically changeable.

The second chaff sieve 39 also has the same configuration as the first chaff sieve 38. An angle control mechanism capable of changing the inclination of chaff lips of the second chaff sieve 39 is also provided such that the inclination angle of the chaff lips is automatically changeable.

### Conveying Apparatus

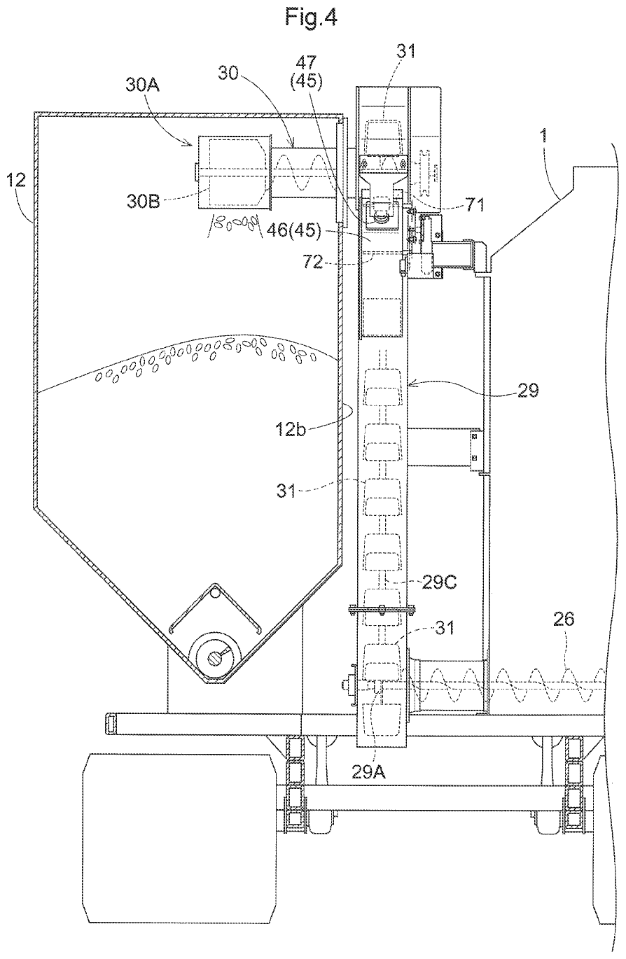

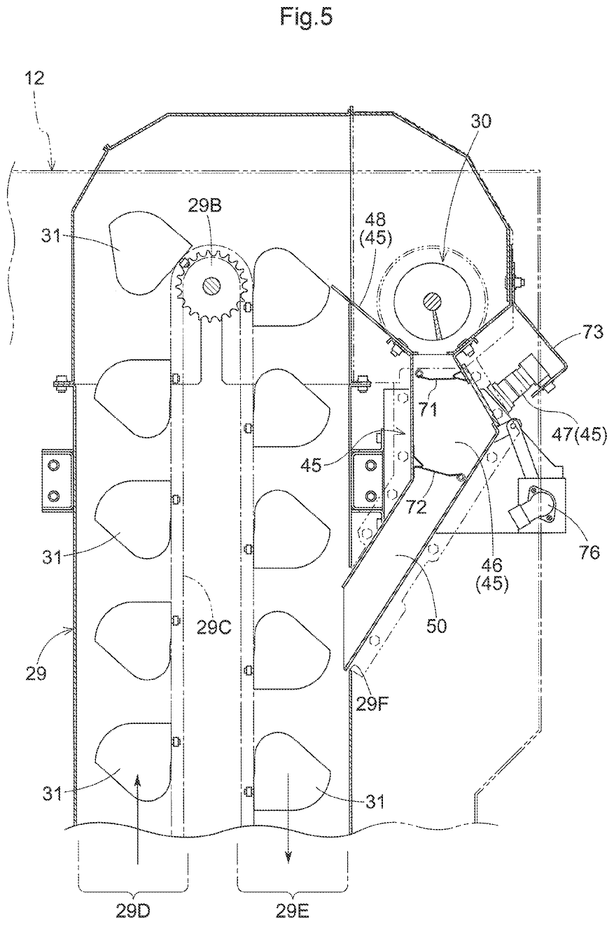

The combine has a grain elevator 29 that conveys separated material collected by the primary-material collecting section 26 to the grain tank 12, as shown in FIGS. 4 and 5. The grain elevator 29 is arranged between the threshing apparatus 1 and the grain tank 12, and stands in the vertical direction. The grain elevator 29 is constituted by a bucket conveyor. Separated material lifted by the grain elevator 29 is delivered to a lateral-feed conveying device 30 at an upper end of the grain elevator 29. The lateral-feed conveying device 30 has a screw and is inserted into the grain tank 12 from a front left wall thereof. The lateral-feed conveying device 30 has a grain releasing device 30A at an end on the inner side of the tank. The grain releasing device 30A has a plate-like releasing rotator 30B, which integrally rotates together with the screw. Separated material is laterally fed by the lateral-feed conveying device 30 and ultimately thrown into the grain tank 12 by the grain releasing device 30A.

The grain elevator 29 has a plurality of buckets 31 that are attached at regular spacing to the outer side of an endless rotating chain 29C wound around a driving sprocket 29A and a driven sprocket 29B, as shown in FIGS. 4 and 5. The grain elevator 29 has a feeding path 29D through which the buckets 31 containing separated material ascends, and a return path 29E through which the buckets 31 descend after discharging the separated material to the lateral-feed conveying device 30. The feeding path 29D and the return path 29E are arranged side by side along a left wall 12b of the grain tank 12 such that the feeding path 29D is located on the rear side.

The grain elevator 29 and the lateral-feed conveying device 30 correspond to a “conveying apparatus” of the present invention. The conveying path of the conveying apparatus is a path from where separated material is collected by the primary-material collecting section 26 to where the collected separated material is thrown into the grain tank 12.

Grain Distinguishing Device

Next, an example configuration of a grain distinguishing device 45 that includes a temporary storage section 46 will be described with reference to FIGS. 3 to 8.

The grain distinguishing device 45 is located next to the grain elevator 29 along the left wall 12b of the grain tank 12, at a position in the front of the grain elevator 29. The grain distinguishing device 45 includes a temporary storage section 46, an image capture unit 47, a guide section 48, and a discharge section 50. The grain distinguishing device 45 is supported by the lateral-feed conveying device 30 and the grain elevator 29.

The guide section 48 is an inclined plate extending downward from slightly below the upper end of a region where the buckets 31 of the grain elevator 29 move, toward a position that is below the lateral-feed conveying device 30 and near the upper end of the temporary storage section 46. The guide section 48 delivers grain discharged from the buckets 31 of the grain elevator 29 to the lateral-feed conveying device 30 and the temporary storage section 46.

The temporary storage section 46 contains a lid portion 71 and a bottom portion 72. The lid portion 71 pivots up and down along a shaft 71d located at an end of the grain distinguishing device 45 on the grain elevator 29 side. The grain elevator 29 has a side wall 45b that faces the shaft 71d and has a protrusion 71a protruding toward the inner side of the temporary storage section 46. The lid portion 71 comes into contact with the protrusion 71a and closes as a result of pivoting upward, and opens by pivoting downward. The bottom portion 72 is located in a region of the grain distinguishing device 45 that is below the lid portion 71. The bottom portion 72 pivots up and down along a shaft 72d located at an end of the grain distinguishing device 45 on the side distant from the grain elevator 29. The grain elevator 29 has a side wall 45a that faces the shaft 72d and has a protrusion 72a protruding toward the inner side of the temporary storage section 46. The bottom portion 72 comes into contact with the protrusion 72a and closes by pivoting upward, and opens by pivoting downward. The temporary storage section 46 is a region between the lid portion 71 and the bottom portion 72. The lid portion 71 constitutes an upper face of the temporary storage section 46, and the bottom portion 72 constitutes a bottom face of the temporary storage section 46. Upon the lid portion 71 opening, an upper region of the temporary storage section 46 opens, and separated material transferred from the guide section 48 falls freely into the temporary storage section 46. In this state, upon the bottom portion 72 pivoting to come into contact with the protrusion 72a and closing, the temporary storage section 46 is closed by the bottom portion 72 (storing state), and some of the separated material that is being conveyed is stored in the temporary storage section 46. Upon the bottom portion 72 opening, the separated material stored in the temporary storage section 46 falls freely and is released from a lower part of the temporary storage section 46 (discharging state). Upon the lid portion 71 closing, separated material delivered from the guide section 48 is guided to the lateral-feed conveying device 30 and released into the grain tank 12 via the releasing rotator 30B. That is, the lid portion 71 partially constitutes a lower part of a handover section (conveying path) between the grain elevator 29 and the lateral-feed conveying device 30.

A lever 71b that pivots along the shaft 71d is fixed to the lid portion 71, and the lid portion 71 pivots in the same direction as the lever 71b in accordance with a pivot thereof. The lever 71b is located to the outer side of a side face of the grain distinguishing device 45, and is arranged at a position facing the lid portion 71 with the side face of the grain distinguishing device 45 therebetween. The lever 71b is biased upward by a helical torsion coil spring 71c, which is fitted onto the shaft 71d. As a result, the lid portion 71 is biased to be closed. Similarly, a lever 72b that pivots along the shaft 72d is fixed to the bottom portion 72. The bottom portion 72 pivots in the same direction as the lever 72b in accordance with a pivot thereof. The lever 72b is located on the outer side of a side face of the grain distinguishing device 45 and is arranged at a position facing the bottom portion 72 with the side face of the grain distinguishing device 45 therebetween. The lever 72b is biased upward by a helical torsion coil spring 72c, which is fitted onto the shaft 72d. As a result, the bottom portion 72 is biased to be closed.

The grain distinguishing device 45 has a motor 74 (which corresponds to an “actuator”) that opens and closes the lid portion 71 and the bottom portion 72, and a link 75 that is driven by the motor 74. The link 75 includes a stay 75a, a stay 75b, and a stay 75c. The stay 75a bends and is supported by a motor shaft 74a of the motor 74 at the bent portion. The stay 75a pivots along the motor shaft 74a in accordance with a rotation of the motor shaft 74a. The stay 75a has a protrusion 75e at one end and a protrusion 75f at another end. The stay 75b has one end supported by the protrusion 75e. The stays 75a and 75b pivot with respect to each other about the protrusion 75e. The stay 75b has another end supported by one end of the stay 75c. The stays 75b and 75c pivot with respect to each other. The stay 75c has another end supported by a shaft 75d of an angle sensor 76.

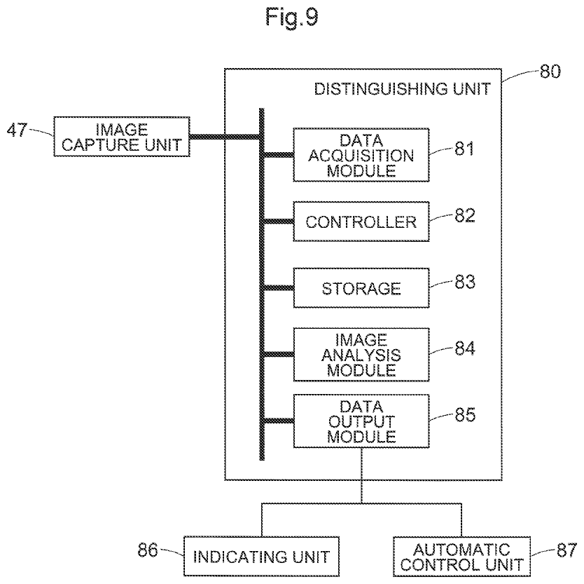

The protrusion 75f presses the lever 71b as the stay 75a pivots as a result of being driven by the motor 74, and pivots the lever 71b downward to displace and open the lid portion 71. That is, the lid portion 71 is opened and closed by the link 75 and the lever 71b pivoting in response to being driven by the motor 74. The protrusion 75e presses the lever 72b as the stay 75a pivots as a result of being driven by the motor 74, and pivots the lever 72b downward to displace and open the bottom portion 72. That is, the bottom portion 72 is opened and closed by the link 75 operating and the lever 72b pivoting in response to being driven by the motor 74. Thus, the lid portion 71 and the bottom portion 72 are displaced to open and close in accordance with the angle at which the stay 75a pivots in response to an operation of the link 75. Note that the driving of the motor 74 is controlled by a later-described controller 82 (see FIG. 9) and the like. In addition, the shaft 75d is provided with an angle sensor 76 for detecting the pivot angle of the stay 75c. The angle sensor 76 is capable of detecting the state of the stay 75a and the respective states of the levers 71b and 72b and checking whether the lid portion 71 and the bottom portion 72 is open or closed, based on the pivot angle of the stay 75c. Values detected by the angle sensor 76 are sent to the later-described controller 82 (see FIG. 9) and the like and used to control the motor 74.

The discharge section 50 corresponds to a part of the grain distinguishing device 45 that is below the temporary storage section 46. The discharge section 50 is continuous with the temporary storage section 46 and inclines downward as it approaches the grain elevator 29, and has a lower end connected to the grain elevator 29. The grain elevator 29 has an opening 29F in its side face on the return path 29E side. The discharge section 50 has a lower end joined to the opening 29F. This configuration makes separated material released from the temporary storage section 46 return to the return path 29E of the grain elevator 29 from the opening 29F through the discharge section 50. The returned separated material is conveyed again toward the grain tank 12 by the grain elevator 29.

Further, the grain distinguishing device 45 has the image capture unit 47. The image capture unit 47 is supported by a stay 73 located on an outer wall of the lateral-feed conveying device 30. The side wall 45b of the grain distinguishing device 45 that is located on the distal side with respect to the grain elevator 29 bends in a region where the temporary storage section 46 is located. The image capture unit 47 is arranged with a lens thereof facing the upper side of the side wall 45b of the grain distinguishing device 45 with respect to the bent portion. The upper side of the side wall 45b of the grain distinguishing device 45 with respect to the bent portion has an opening 45c, to which a permeable member 45d is fitted. The permeable member 45d is a transparent or highly translucent member, such as glass or acryl. The image capture unit 47 captures images of separated material within the temporary storage section 46 through the permeable member 45d. The image capture unit 47 then sends the captured images to a later-described distinguishing unit 80 (see FIG. 9).

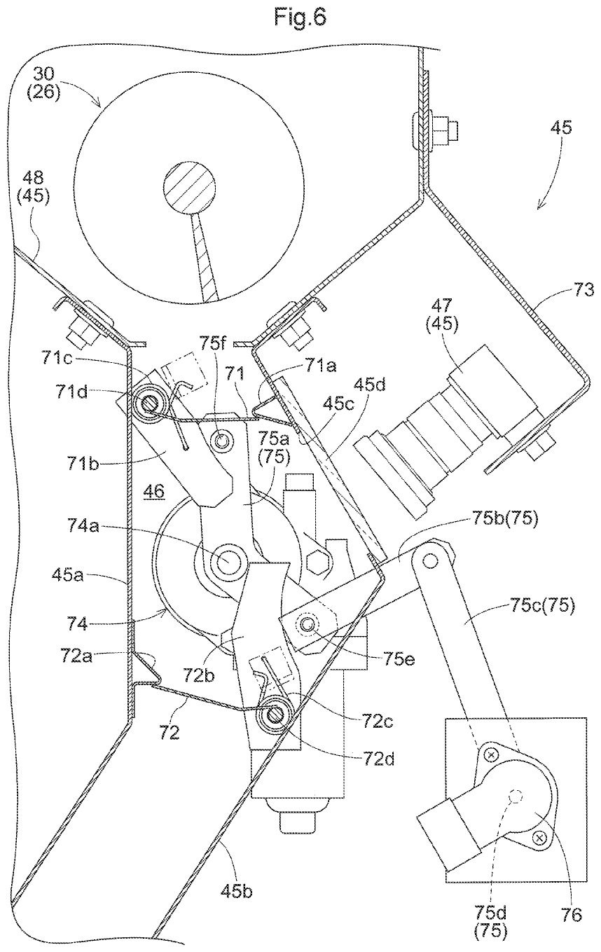

Next, a description will be given of a configuration for opening and closing the lid portion 71 and the bottom portion 72, with reference to FIGS. 6 to 8.

While the link 75 is in a state where the protrusion 75f is not in contact with the lever 71b and the protrusion 75e is not in contact with the lever 72b, the lever 71b is biased to close the lid portion 71 and the bottom portion 72, as shown in FIG. 6. Since the lid portion 71 is closed in this state, separated material delivered from the guide section 48 is guided to the lateral-feed conveying device 30 and released into the grain tank 12 via the releasing rotator 30B.

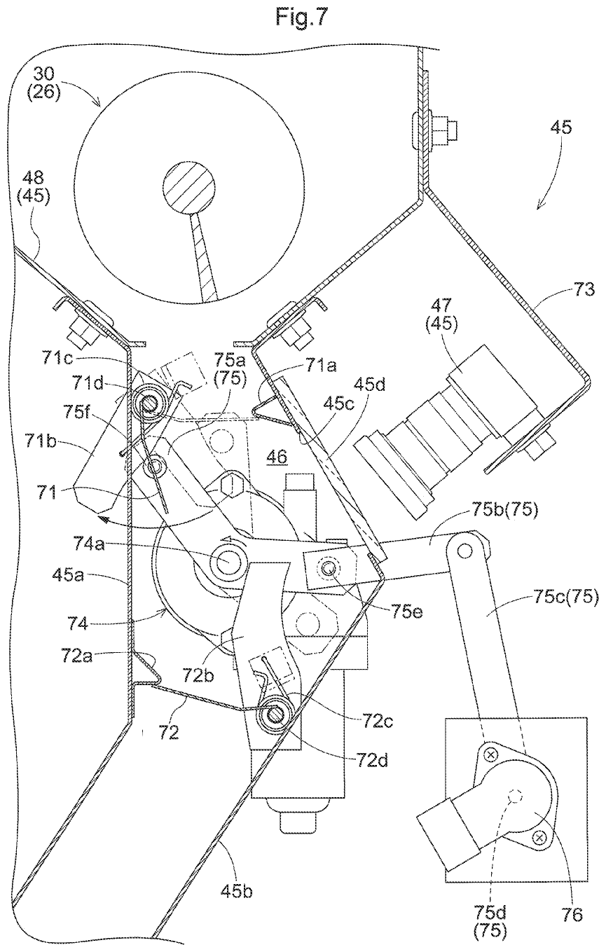

Upon the link 75 moving from the state shown in FIG. 6 such that the protrusion 75f presses the lever 71b with the protrusion 75e not in contact with the lever 72b, the lever 71b pivots to open the lid portion 71, and the bottom portion 72 is kept closed, as shown in FIG. 7. Since the lid portion 71 is open in this state (storing state), separated material delivered from the guide section 48 is guided to the temporary storage section 46, and the guided separated material is stored in the temporary storage section 46 since the bottom portion 72 is closed.

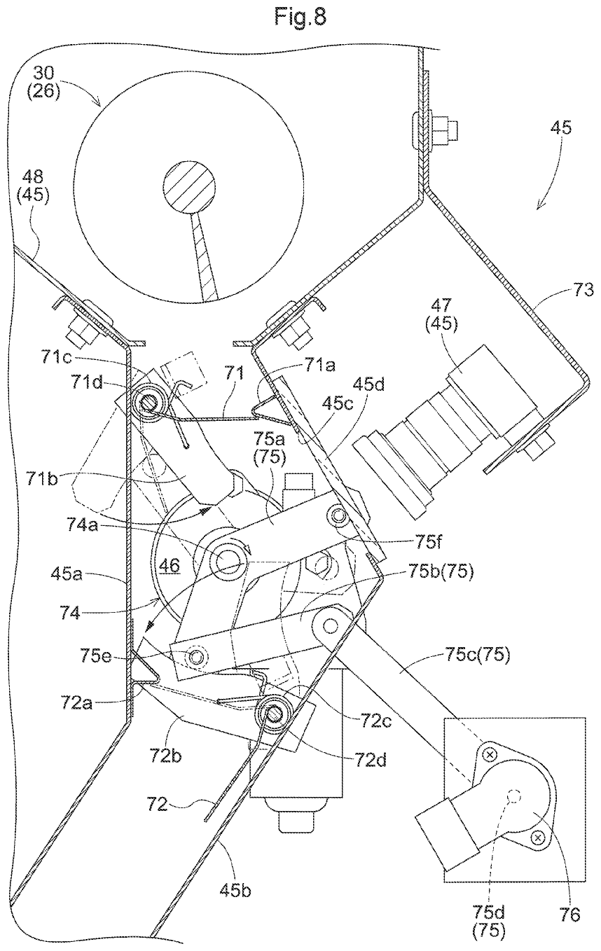

Upon the link 75 moving such that the protrusion 75f moves away from the lever 71b while the protrusion 75e presses the lever 72b with separated material stored in the temporary storage section 46, the lever 71b is biased to close the lid portion 71, and the bottom portion 72 is opened, as shown in FIG. 8. Since the bottom portion 72 is open in this state (releasing state), the separated material stored in the temporary storage section 46 is released downward from the temporary storage section 46. Also, since the lid portion 71 is closed, separated material delivered from the guide section 48 is guided to the lateral-feed conveying device 30, but is not guided to the temporary storage section 46. The separated material released from the temporary storage section 46 is returned to the return path 29E through the discharge section 50.

The lid portion 71 and the bottom portion 72 are displaced to open and/or close from the state (image capture-ready state) in FIG. 6 to the state (storing state) in FIG. 7, and from the state (storing state) in FIG. 7 to the state (discharging state) in FIG. 8 through the state (image capture-ready state) in FIG. 6. Thereafter, the lid portion 71 and the bottom portion 72 return to the state (image capture-ready state) shown in FIG. 6, and the above state transition (cycle) is repeated. The image capture unit 47 captures an image of stored separated material in the state (image capture-ready state) in FIG. 6 in the process of the transition from the state (storing state) in FIG. 7 to the state (discharging state) in FIG. 8. The image capture unit 47 is able to capture an image of stationary separated material with no new separated material flowing in by capturing the image with the lid portion 71 closed, as shown in FIG. 6. In addition, the image capture unit 47 is able to capture an image of the stored separated material without being disturbed by newly flowing separated material. Further, dust or the like may fly within the temporary storage section 46 while new separated material is flowing in. However, dust or the like is restrained from flying by the closed lid portion 71. For these reasons, the image capture unit 47 is able to capture a clear image of separated material by capturing the image with the lid portion 71 closed.

Grain Distinction

As mentioned above, the image capture unit 47 captures an image of separated material that is being conveyed. The captured image is analyzed to distinguish normal grain (unhulled grain) contained in the separated material from other foreign matter. Examples of the foreign matter include foreign substances such as waste straw, bran (empty hulls), rachis branches, damaged grain, and spotted dirty grain. A configuration for distinguishing separated material will be described below with reference to FIG. 9.

The distinguishing unit 80 distinguishes separated material. The distinguishing unit 80 has a data acquisition module 81, a controller 82, a storage 83, an image analysis module 84, and a data output module 85, which can send and receive data to and from each other via a bus or a LAN. The distinguishing unit 80 is communicably connected to the aforementioned image capture unit 47, acquires a captured image by capturing an image of separated material, and gives an image capture instruction to the image capture unit 47.

The controller 82 controls the operation of the data acquisition module 81, the controller 82, the storage 83, the image analysis module 84, and the data output module 85. The controller 82 includes a processor such as an ECU or a CPU. The controller 82 may be operated by hardware, or may be operated by the processor executing a program. In this case, the program is stored in the later-described storage 83. Further, the controller 82 controls the operation of the image capture unit 47.

The controller 82 receives a value detected by the angle sensor 76 to detect whether the lid portion 71 and the bottom portion 72 are open or closed, and controls the operation of the motor 74. Based on the open or closed state of the lid portion 71 and the bottom portion 72, the controller 82 detects that separated material is being stored in the temporary storage section 46, and controls the image capture of the image capture unit 47 in response to the detection.

The data acquisition module 81 acquires a captured image by capturing an image of separated material that is sent by the image capture unit 47 and sends the acquired captured image to the storage 83, in response to control by the controller 82.

The storage 83 stores the captured image sent from the data acquisition module 81, and stores the analysis results sent from the later-described image analysis module 84.

The image analysis module 84 acquires the captured image stored in the storage 83, analyzes the image, distinguishes between normal grain and foreign matter other than the normal grain in the separated material, and calculates the proportion of the foreign matter to the separated material, in response to control by the controller 82. The image analysis module 84 transmits, to the storage 83, the distinction results and the calculated proportion of the foreign matter as the analysis results. Examples of the foreign matter include foreign substances, damaged grain, dirty grain, rachis branches, and bran. Note that the image analysis module 84 may distinguish between normal grain and foreign matter, but may optionally distinguish between normal grain and at least one of the specific types of abnormality including foreign substances, damaged grain, dirty grain, rachis branches, and bran, and calculate the proportions of the normal grain and this specific type of abnormality.

The image analysis module 84 acquires learned data that is stored in advance in the storage 83, and analyzes the captured image received from the storage 83 by inputting the image to the learned data. The learned data is for a neural network or the like trained by machine learning by inputting, to artificial intelligence (AI), a plurality of sample images (which correspond to “images”) as input data and information indicating whether or not each of the sample images is an image of foreign matter as training data.

The data output module 85 acquires the analysis results stored in the storage 83 and outputs the acquired analysis results to the outside of the distinguishing unit 80, in response to control by the controller 82.

Further, the distinguishing unit 80 is communicably connected to an indicating unit 86.

The indicating unit 86 receives the analysis results sent from the data output module 85 of the distinguishing unit 80 and displays information corresponding to the analysis results. The indicating unit 86 may be a display, a lamp, a speaker, or the like.

If, for example, the indicating unit 86 is a display, the indicating unit 86 is capable of displaying images captured by the image capture unit 47 and information representing the proportion of foreign matter and/or the proportion of each specific type of abnormality with text or graphs. If the indicating unit 86 is a lamp or a speaker, it is possible to change the lighting state of the lamp or a sound generated from the speaker in accordance with the proportion of foreign matter and/or the proportion of each specific type of abnormality, and turn on a warning lamp or cause the speaker to generate a warning sound if the proportion of foreign matter and/or the proportion of each specific type of abnormality is greater than a predetermined value.

With the indicating unit 86 indicating information corresponding to the analysis results, an operator is able to estimate the separation accuracy of the separation section 42 and the threshing accuracy of the threshing section 41 by visually recognizing foreign matter contained in separated material and/or checking the proportion of foreign matter. The operator is then able to operate the dust feed valve control mechanism, the winnower control mechanism, and the lip control mechanism in accordance with the estimation results to adjust the inclination angle of the dust feed valves 53a, the intensity of the separation wind of the winnower 19, and the inclination angles of the chaff lips of the first chaff sieve 38 and the second chaff sieve 39, thereby bringing the separation accuracy of the separation section 42 and the threshing accuracy of the threshing section 41 to an appropriate state. Since the yield of crop per hour varies as a result of changing the traveling speed, the traveling speed may be changed in accordance with the estimation results.

Variations

(1) The lid portion 71 and the bottom portion 72 are not limited to being opened and closed in conjunction with the link 75. The lid portion 71 and the bottom portion 72 may be opened and closed in any manner. For example, the lid portion 71 and the bottom portion 72 may be opened and closed independently.

(2) In the above embodiment, images of separated material are not limited to being captured with the lid portion 71 closed. If separated material is stored at the time of image capture, images of the separated material may alternatively be captured with the lid portion 71 open. If separated material is flowing into the temporary storage section 46 at this time, it may be difficult to capture an image of stored separated material due to the flowing separated material, or dust or the like accompanying the flowing separated material. It is therefore favorable to separately provide a configuration for interrupting the inflow of separated material at least during image capture, in addition to the lid portion 71.

(3) In the above embodiment, the image capture unit 47 is not limited to being located close to the temporary storage section 46, and may be located at any position as long as the image capture unit 47 is capable of capturing images of stored separated material.

(4) The temporary storage section 46 may have a sensor for detecting that an appropriate amount of separated material for image capture is stored. Upon the sensor detecting that an appropriate amount of separated material for image capture is stored, the sensor sends information regarding the detection to the controller 82, which can then control the image capture unit 47 in accordance with the detected state. This configuration enables images of optimally stored separated material to be captured more reliably.

(5) At least the temporary storage section 46 of the grain distinguishing device 45 in the above embodiment is not limited to being located at a position adjacent to the grain elevator 29, and may alternatively be located at any intermediate position on the separated material conveying path including the grain elevator 29 and the lateral-feed conveying device 30 from the primary-material collecting section 26 to the grain tank 12. The temporary storage section 46 may alternatively be located in the grain tank 12, and may be configured to temporarily store separated material released from the releasing rotator 30B. In any configuration, separated material that is temporarily stored in the temporary storage section 46 and subjected to image capture need only be returned to any position in the conveying path or released to the grain tank 12 after the image capture.

(6) There are cases where the grain tank 12 has a taste sensor (not shown) for measuring the quality of grain (separated material). The taste sensor temporarily stores at least some of the separated material conveyed to the grain tank 12, and measures the grain quality while the separated material is temporarily stored in the taste sensor. The taste sensor can also serve as the temporary storage section 46. In this case, the taste sensor is provided with an image capture unit 47 capable of capturing images of the temporarily stored grain (separated material). The image capture unit 47 captures an image of separated material while the grain quality is measured, or before or after the grain quality is measured. This configuration enables images of separated material to be captured only by providing the image capture unit 47 without providing a dedicated grain distinguishing device 45. Images of separated material can be captured with a simple configuration.

(7) The image capture unit 47 is not limited to being provided at the location in the above embodiment, and may alternatively be provided at any other location as long as it can captures images of separated material. For example, a configuration may be employed in which the temporary storage section 46 has a permeable window, and the image capture unit 47, which is located outside the window, captures images of separated material through the window.

(8) In the above embodiment, the traveling speed, the operation of the threshing section 41, and the operation of separation section 42 may also be automatically controlled in accordance with the results of analyzing captured images. In this case, an automatic control unit 87, which is communicably connected to the distinguishing unit 80, is provided. The automatic control unit 87 receives the analysis results sent from the data output module 85 of the distinguishing unit 80, and controls the traveling speed, the operation of the threshing section 41, and the operation of the separation section 42 in accordance with the analysis results.

(9) In the above embodiment, the image analysis module 84 is not limited to using learned data generated through machine learning, and may alternatively analyze images using any method, distinguish between separated material, and calculate the proportions.

(10) In the above embodiment, captured images may be either still images or moving images. In the case of moving images, the number of frames of each captured image of separated material per unit time is greater than that in the case of still images. Thus, foreign matter can be detected more accurately.

(11) Although the above embodiment has described a combine, processing performed by the functional parts of the above embodiment may also be adopted as a grain separation method. In this case, the grain separation method may include: a reaping step of reaping planted grain culms in a field; a threshing step of threshing the reaped grain culms and separating the reaped grain culms into separated material containing normal grain and material to be discharged other than the separated material, with use of a threshing apparatus 1; a storing step of storing the separated material in a grain tank 12; a conveying step of conveying the separated material from the threshing apparatus 1 to the grain tank 12, with use of a conveying apparatus; a temporary storage step of taking out some of the separated material that is being conveyed by the conveying apparatus and storing the taken-out separated material in a temporary storage section 46; an image capture step of capturing an image of the separated material stored in the temporary storage section 46, with use of an image capture unit 47; and an image analysis step of analyzing the image captured by the image capture unit 47, and performing distinguishing processing for distinguishing the normal grain in the separated material stored in the temporary storage section 46 from foreign matter other than the normal grain, the foreign matter being mixed in the separated material.

(12) Although the above embodiment has described a combine, processing performed by the functional parts of the above embodiment may also be adopted as a grain separation system. In this case, the grain separation system may include: a reaper configured to reap planted grain culms in a field; a threshing apparatus 1 configured to thresh the reaped grain culms and separate the reaped grain culms into separated material containing normal grain and material to be discharged other than the separated material; a grain tank 12 in which the separated material is storable; a conveying apparatus configured to convey the separated material from the threshing apparatus 1 to the grain tank 12; a temporary storage section 46 configured to take out and store some of the separated material that is being conveyed by the conveying apparatus; an image capture unit 47 configured to capture an image of the separated material stored in the temporary storage section 46; and an image analysis module 84 configured to analyze the image captured by the image capture unit 47, and perform distinguishing processing for distinguishing the normal grain in the separated material stored in the temporary storage section 46 from foreign matter other than the normal grain, the foreign matter being mixed in the separated material.

(13) The functional parts of the above embodiment may also be adopted as a grain separation program. In this case, the grain separation program may cause a computer to implement: a reaping function of reaping planted grain culms in a field; a threshing function of threshing the reaped grain culms and separating the reaped grain culms into separated material containing normal grain and material to be discharged other than the separated material, with use of a threshing apparatus 1; a storing function of storing the separated material in a grain tank 12; a conveying function of conveying the separated material from the threshing apparatus 1 to the grain tank 12, with use of a conveying apparatus; a temporary storage function of taking out some of the separated material that is being conveyed by the conveying apparatus and storing the taken-out separated material in a temporary storage section 46; an image capture function of capturing an image of the separated material stored in the temporary storage section 46, with use of an image capture unit 47; and an image analysis function of analyzing the image captured by the image capture unit 47 and performing distinguishing processing for distinguishing the normal grain in the separated material stored in the temporary storage section 46 from foreign matter other than the normal grain, the foreign matter being mixed in the separated material.

Further, this grain separation program may also be recorded in a recording medium.

### Second Embodiment

A combine according to the present invention is capable of inspecting the quality of grain while the grain is being harvested. The following is a description of a combine 120 of the present embodiment.

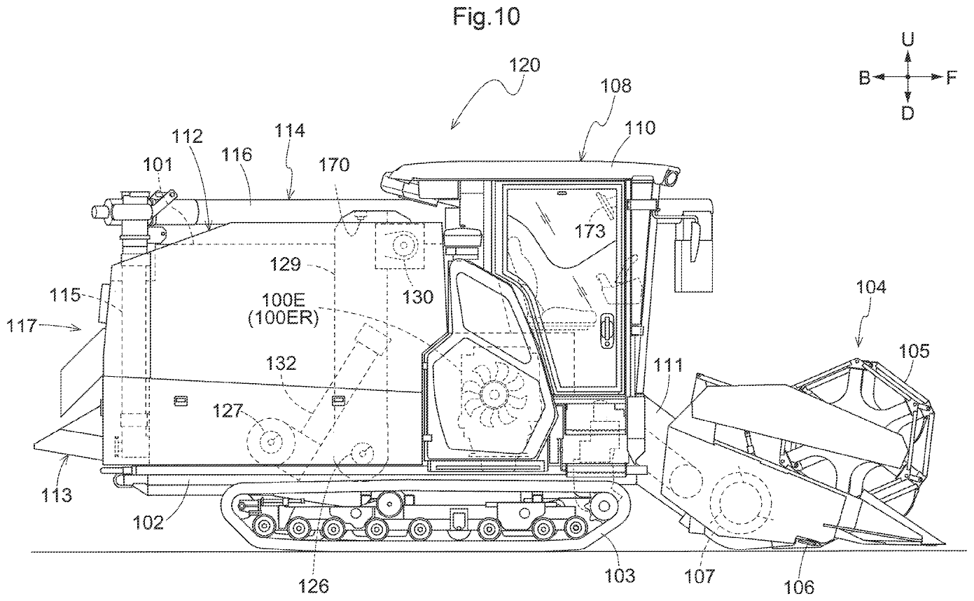

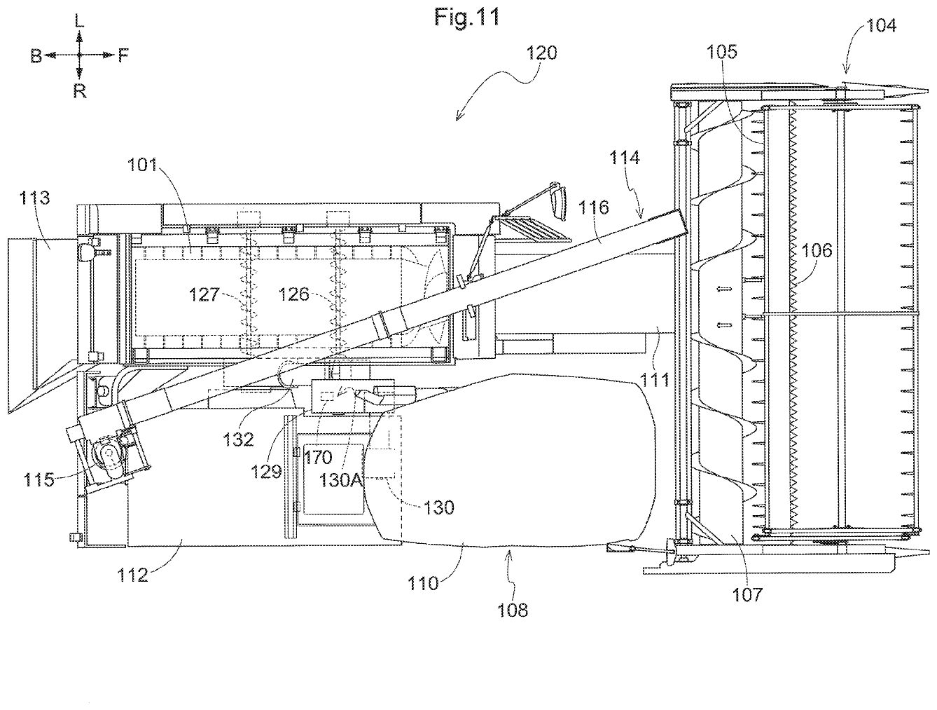

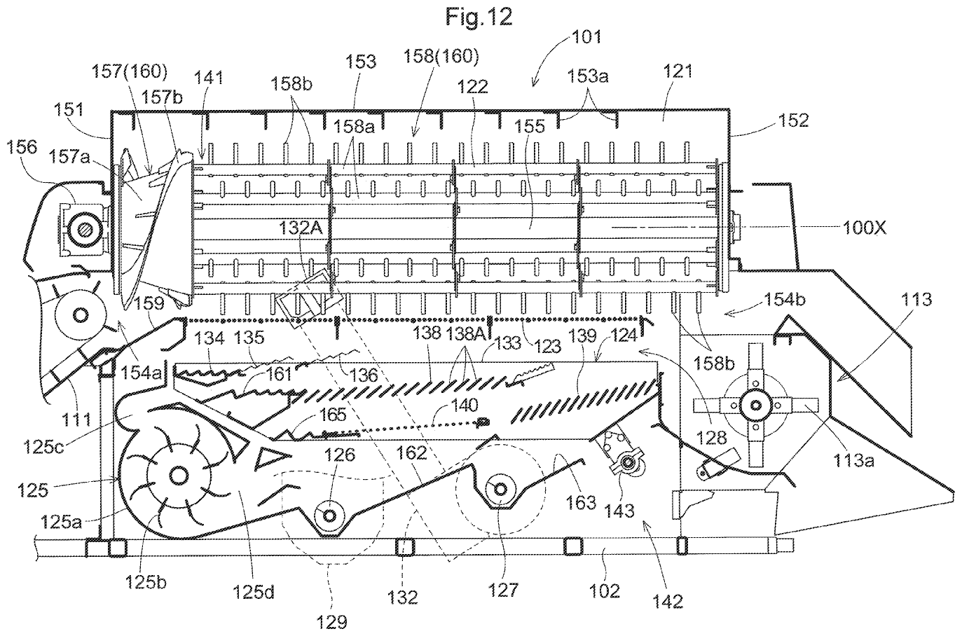

FIG. 10 is a side view of the combine 120. FIG. 11 is a plan view of the combine 120. FIG. 12 is a cross-sectional view of a threshing apparatus 101 included in the combine 120. Note that the following description will take a normal combine as an example of the combine 120. Needless to say, the combine 120 may be of a head-feeding type.

In the present embodiment, “front” (the direction of F arrow in FIG. 1) means the front in the front-back direction (travel direction) of the body of the combine, and “back” (the direction of B arrow in FIG. 1) means the back in the front-back direction of the body of the combine to facilitate understanding, unless stated otherwise. “Upper/above” (the direction of U arrow in FIG. 10) and “lower/below” (the direction of D arrow in FIG. 10) refer to positional relationships in the vertical direction of the body of the combine, and indicate relationships in terms of the ground height. The “left-right direction” and the “lateral direction” mean the transverse direction of the body of the combine (widthwise direction of the body of the combine) perpendicular to the front-back direction of the body of the combine. In other words, “left” (the direction of L arrow in FIG. 11) and “right” (the direction of arrow R in FIG. 11) respectively mean the leftward and rightward directions of the body of the combine.

The combine 120 has a body frame 102 and crawler traveling devices 103, as shown in FIGS. 10 and 11. The combine 120 has a reaper 104 for reaping planted grain culms in the front of traveling body 117. The reaper 104 has a raking reel 105 for raking planted grain culms, a blade 106 for cutting planted grain culms, and an auger 107 for raking reaped grain culms.

The combine 120 has a cab 108 on the front right side of the traveling body 117. The cab 108 includes a cabin 110 that allows an operator to enter. The combine 120 has an engine compartment 100ER below the cabin 110. The engine compartment 100ER accommodates not only an engine 100E but also an exhaust purifier, a cooling fan, a radiator, and the like. Motive power of the engine 100E is transmitted to the crawler traveling devices 103, a later-described threshing unit 141 and separation unit 142, and the like, by a motive power transmission structure (not shown).

The threshing apparatus 101 for threshing reaped grain culms is located behind the reaper 104. The combine 120 has a feeder 111 that extends between the reaper 104 and the threshing apparatus 101 and conveys reaped grain culms to the threshing apparatus 101. The combine 120 has a grain tank 112 for storing threshed grain on a side of the threshing apparatus 101. The grain tank 112 is pivotable and openable/closable about an axis extending in the vertical direction, between a work position and a maintenance position. The combine 120 has a waste straw chopper 113 with a rotary blade 113a behind the threshing apparatus 101.

The combine 120 has a grain unloader 114 for discharging grain in the grain tank 112 to the outside. The grain unloader 114 includes a vertical conveyor 115 for conveying grain in the grain tank 112 upward, and a lateral conveyor 116 for conveying grain from the vertical conveyor 115 to the outside of the body of the combine 120. The grain unloader 114 is turnable about an axis of the vertical conveyor 115. The vertical conveyor 115 has a lower end connected and in communication with a bottom of the grain tank 112. An end of the lateral conveyor 116 on the vertical conveyor 115 side is connected and in communication with an upper end of the vertical conveyor 115, and is supported in a vertically pivotable manner.

The threshing apparatus 101 in the present embodiment is provided on the traveling body 117. The threshing apparatus 101 has the threshing unit 141 and the separation unit 142, as mentioned above. The threshing unit 141 threshes grain culms reaped by the reaper 104. Grain threshed by the threshing unit 141 is discharged as threshed material. The separation unit 142 separates threshed material discharged from the threshing unit 141 to obtain separated material. Accordingly, the threshing unit 141 and the separation unit 142 are provided on the traveling body 117. The threshing unit 141 is arranged in an upper part of the threshing apparatus 101, and a receiving net 123 is located below the threshing unit 141. The separation unit 142 is arranged below the threshing unit 141, and separates grain from threshed material leaking down from the receiving net 123. The separation unit 142 includes a shaking separator 124, a primary-material collecting section 126, a secondary-material collecting section 127, and a secondary-material returning section 132.

The threshing unit 141 has a threshing cylinder 122 accommodated in a threshing chamber 121, and the receiving net 123 below the threshing cylinder 122. The threshing chamber 121 is formed as a space surrounded by a front wall 151, a back wall 152, left and right side walls, and a top plate 153 that covers the upper part. The threshing chamber 121 has a feeding port 154a for feeding harvested material at a lower position on the front wall 151, and a guide bottom plate 159 arranged below the feeding port 154a. The threshing chamber 121 also has a dust outlet 154b on the lower side of the back wall 152.

The threshing cylinder 122 has a body 160 and a rotating support shaft 155. The body 160 is formed by integrating a raking section 157 at a front end with a processing section 158 located at a position behind the raking section 157, as shown in FIG. 12. The raking section 157 has a double-helix spiral vane 157b at the periphery of a tapered base 157a, the diameter of which decreases toward a front end of the threshing cylinder 122. The processing section 158 has a plurality of bar-shaped threshing tooth support members 158a and a plurality of threshing teeth 158b. The plurality of bar-shaped threshing tooth support members 158a are spaced apart from each other at predetermined spacing in the circumferential direction of the cylindrical body 160. The plurality of threshing teeth 158b protrude from the periphery of the respective threshing tooth support members 158a, and are attached thereto, spaced apart from each other at predetermined spacing along a rotation axis 100X extending in the front-back direction.

The body 160 is coaxial with the rotation axis 100X and integrally rotates with a rotating support shaft 155, which penetrates the front wall 151 and the back wall 152 in the front-back direction. That is, a front end of the rotating support shaft 155 is rotatably supported by the front wall 151 via a bearing, and similarly, a rear end of the rotating support shaft 155 is rotatably supported by the back wall 152 via a bearing. A driving rotational force is transmitted from a rotational drive mechanism 156 to the front end of the rotating support shaft 155 in this threshing unit 141.

The top plate 153 has, on its inner side (lower side), a plurality of plate-shaped dust feed valves 153a located at predetermined spacing along the front-back direction. The plurality of dust feed valves 153a are inclined with respect to the rotation axis 100X in a plan view in such a manner as to exert a force that moves backward processed material rotating together with the threshing cylinder 122 in the threshing chamber 121. The angle at which the dust feed valves 153a are attached to the top plate 153 is adjustable in the present embodiment. The amount of processed material in the body 160 to be fed is changeable by changing this angle.

The receiving net 123 has an arc shape as viewed along the rotation axis 100X in such a manner as to surround the threshing cylinder 122 from below in a region extending between both ends thereof. The receiving net 123 is a combination of a plurality of vertical frames arranged at predetermined spacing along the front-back direction and a lateral frame facing forward and backward and supported by the vertical frames. Thus, the receiving net 123 has gaps from which processed material is able to leak downward.

Reaped grain culms supplied to the threshing chamber 121 in the combine 120 of the present embodiment are referred to as harvested material, and the harvested material processed in this threshing chamber 121 is referred to as processed material (which corresponds to “threshed material”). Processed material contains grain and cut straw or the like. “Primary material” refers to processed grain that contains a large proportion of grain, and “secondary material” refers to processed material that contains grain that is not sufficiently processed into simple grain, and cut straw or the like.

Harvested material from the feeder 111 is supplied to the threshing chamber 121 via the feeding port 154a in the threshing unit 141. The fed harvested material is raked toward the rear side of the threshing cylinder 122 along the guide bottom plate 159 by the spiral vane 157b of the raking section 157, and is fed to the processing section 158. The harvested material in the processing section 158 is processed by the threshing teeth 158b and the receiving net 123 as the threshing cylinder 122 rotates, and is thus threshed.

While threshing is thus being performed, processed material rotates with the threshing cylinder 122. As a result, the processed material comes into contact with the dust feed valves 153a and is threshed while being conveyed toward the rear side of the threshing chamber 121. Grain obtained through the threshing and short cut straw or the like leaks downward through the receiving net 123 and falls down to the separation unit 142. Meanwhile, processed material that is unable to leak downward through the receiving net 123 (grain culms, long cut straw, etc.) is discharged from the dust outlet 154b to the outside of the threshing chamber 121.

The separation unit 142 has the shaking separator 124 for separating grain (primary material) from processed material by shaking in an environment where separation wind is fed from a winnower 125, as shown in FIG. 12. The primary-material collecting section 126 and the secondary-material collecting section 127 are arranged below the shaking separator 124.

The winnower 125 is provided in the separation unit 142 and generates the separation wind along the direction in which processed material is conveyed. The winnower 125 accommodates a winnower body having a plurality of rotating blades 125b within a fan case 125a. The fan case 125a has, in its upper part, an upper outlet 125c for sending the separation wind along an upper face of an upper grain pan 161, and a rear outlet 125d for sending the separation wind backward.

The primary-material collecting section 126 collects processed material as primary material. Processed material is guided to the primary-material collecting section 126 by a primary-material guide 162. The primary-material collecting section 126 is configured as a primary-material screw for laterally conveying the primary material (primary grain) guided by the primary-material guide 162. The primary material collected by the primary-material collecting section 126 is conveyed upward (elevated) toward the grain tank 112 by a primary-material collection conveyor 129. Accordingly, the separated material separated by the separation unit 142 is conveyed to and stored in the grain tank 112. The primary material conveyed by the primary-material collection conveyor 129 is conveyed rightward by a storage screw 130 and fed to the grain tank 112. The primary-material collection conveyor 129 corresponds to a bucket conveyor.

The secondary-material collecting section 127 collects, as secondary material, processed material that is not separated as separated material among threshed material. Although the details will be described later, “separated material” refers to grain separated by the shaking separator 124. Accordingly, processed material that are not separated as separated material corresponds to grain that is not separated by the shaking separator 124, grain culms, and long cut straw or the like, and is referred to as “secondary material”. Such secondary material is guided to the secondary-material collecting section 127 by a secondary-material guide 163. The secondary-material collecting section 127 is configured as a secondary-material screw for laterally conveying secondary material guided by the secondary-material guide 163. The secondary material collected by the secondary-material collecting section 127 is conveyed upward and obliquely forward and returned to the upper side (upstream side) of the shaking separator 124 by the secondary-material returning section 132. The secondary-material returning section 132 corresponds to a screw conveyor.

The primary-material collecting section 126 and the secondary-material collecting section 127 are driven by motive power of the engine 100E that is transmitted by a power transmission structure (not shown).

Motive power of the engine 100E is transmitted to the primary-material collecting section 126, transmitted from the primary-material collecting section 126 to the primary-material collection conveyor 129, and is transmitted from the primary-material collection conveyor 129 to the storage screw 130. The primary-material collection conveyor 129 is located in a right side part (outer part of a right wall) of the threshing apparatus 101.

Motive power of the engine 100E is transmitted to the secondary-material collecting section 127, and is transmitted from the secondary-material collecting section 127 to the secondary-material returning section 132. The secondary-material returning section 132 is located in a right side part (outer side of the right wall) of the threshing apparatus 101.

The shaking separator 124 separates grain from processed material. The shaking separator 124 is located below the receiving net 123, and processed material leaks down from the receiving net 123. The shaking separator 124 has a frame-like sieve case 133 having a rectangular shape in a top view that is shaken in the front-back direction by a shake-drive mechanism 143 with an eccentric cam using an eccentric shaft or the like.

The sieve case 133 includes a first grain pan 134, a plurality of first sieve lines 135, a second sieve line 136, a first chaff sieve 138, a second chaff sieve 139, a grain sieve 140, an upper grain pan 161, and a lower grain pan 165.

The first chaff sieve 138, which has a plurality of chaff lips 138A, is arranged behind the upper grain pan 161. The second chaff sieve 139 is arranged behind the first chaff sieve 138. Note that the plurality of chaff lips 138A are arranged along the conveyance direction (backward direction) in which processed material is conveyed. Each of the plurality of chaff lips 138A is inclined with its rear end raised obliquely upward. The degree of opening of each chaff lip 138A is changeable in the present embodiment. “The degree of opening being changeable” means that the inclination is changed. Specifically, the closer the chaff lips 138A are to being parallel to the front-back direction, the smaller the degree of opening is. The closer the chaff lips 138A are to being parallel to the vertical direction, the larger the degree of opening is. The lower grain pan 165 is arranged below a front end of the first chaff sieve 138. The grain sieve 140, which is a mesh body, is arranged at a position continuous with the rear side of the lower grain pan 165. The aforementioned second chaff sieve 139 is arranged below a rear end of the first chaff sieve 138 and behind the grain sieve 140.

The sieve case 133 has an air path for feeding the separation wind fed from the upper outlet 125c of the winnower 125 along the upper face of the upper grain pan 161, and an air path for feeding the separation wind fed from the rear outlet 125d of the winnower 125 along an upper face of the lower grain pan 165. A rear end (right end in FIG. 12) of the shaking separator 124 and a rear end of the receiving net 123 form a discharge section 128.

The shaking separator 124 of the present embodiment feeds the separation wind from the winnower 125, from the front toward the rear of the body of the combine, and conveys processed material in the sieve case 133 toward the rear of the body of the combine due to the sieve case 133 being shaken by the shake-drive mechanism 143. For this reason, the upstream side of the shaking separator 124 in the direction in which processed grain is conveyed will be referred to as a front end or a front side, and the downstream side will be referred to as a rear end or a rear side in the following description.

The grain sieve 140 is configured as a mesh body formed by combining a plurality of metal wire materials in a mesh-like manner, and allows grain to leak down from the mesh. The first chaff sieve 138 is located above the grain sieve 140, and allows grain that has flowed between the chaff lips 138A of the first chaff sieve 138 to leak down on the grain sieve 140.

This configuration causes processed material that leaks down from the receiving net 123 and is received by the upper grain pan 161 in the separation unit 142 to be fed to the front end of the first chaff sieve 138 as the sieve case 133 shakes. The sieve case 133 also receives most of the processed material leaking down from the receiving net 123.

The first chaff sieve 138 conveys processed material backward through wind separation caused by the separation wind and gravity separation caused during the shake, and leaks grain contained in the processed material at the same time. Culms such as cut straw in the thus-separated processed material are delivered to the second chaff sieve 139, fed toward the back of the sieve case 133 from a rear end of the second chaff sieve 139, and are discharged from the discharge section 128 toward the waste straw chopper 113. The culms discharged from the discharge section 128 are chopped by the waste straw chopper 113 and discharged to the outside of the threshing apparatus 101. Grain that directly leaks down on the second chaff sieve 139 via the receiving net 123 is separated into grain and culms such as cut straw by the second chaff sieve 139.

Here, considering the state of processed material leaking down from the receiving net 123, grain, grain that has not been sufficiently processed into simple grain, or straw pieces among the harvested material fed into the threshing chamber 121 leak down from the receiving net 123 at an early stage while being conveyed within the threshing chamber 121. For this reason, the amount of processed material leaking down in the upstream region in the conveyance direction of the receiving net 123 tends to be greater than that in the downstream region in the conveyance direction. In addition, the amount of processed material leaking down from the front end of the first chaff sieve 138 is greater than that on the rear end side since the processed material is fed to the front end of the first chaff sieve 138 from the upper grain pan 161, as mentioned above.

Some of the processed material leaking down on the front end side of the first chaff sieve 138 is removed by being fed backward by the separation wind immediately after leaking down. Processed material that contains a large proportion of grain is received by an upper face of the grain sieve 140. Furthermore, since the wind pressure and the shaking force of the separation wind acts on the processed material fed to the grain sieve 140, straw or the like contained in the processed material is fed backward on the upper face of the grain sieve 140. The processed material leaking down through the grain sieve 140 contains a large proportion of grain. Grain that leaks down through the grain sieve 140 flows down from the primary-material guide 162 to the primary-material collecting section 126 to be collected by the primary-material collecting section 126, and is stored in the grain tank 112 by the primary-material collection conveyor 129.

Processed material from the rear region of the first chaff sieve 138 is fed to the grain sieve 140, while cut straw or the like among processed material that does not leak down through the grain sieve 140 is fed rearward by the separation wind. Thus, grain is separated without a significantly decrease in the separation efficiency in the rear region of the grain sieve 140.

Furthermore, primary material (grain) that leaks down in the front of the rearmost end of the grain sieve 140 flows down from the primary-material guide 162 to the primary-material collecting section 126 to be collected there, and is stored in the grain tank 112 by the primary-material collection conveyor 129.

On the other hand, processed material that leaks down from the rearmost part of the grain sieve 140 or processed material that falls from the second chaff sieve 139 flows down from the secondary-material guide 163 to the secondary-material collecting section 127 to be collected there, and is returned to the upstream side of the shaking separator 124 by the secondary-material returning section 132. Dust such as waste straw as tertiary processed material generated through the separation is fed backward from the rear end of the shaking separator 124, and is discharged from the discharge section 128 to the waste straw chopper 113.

Secondary material is returned to the upstream side, i.e., the front part of the shaking separator 124 by the secondary-material returning section 132, as mentioned above. Specifically, secondary material is returned to a position on a side of the receiving net 123 in the threshing unit 141 at which secondary material does not pass (flow) through the receiving net 123. Accordingly, the secondary-material returning section 132 has a secondary-material discharge port 132A at a position on the radially outer side of the arc-shaped receiving net 123. Secondary material is discharged at this position.

As mentioned above, grain that has not been sufficiently processed into simple grain or straw pieces among the harvested material fed to the threshing chamber 121 leak down through the receiving net 123 at an early stage while being conveyed within the threshing chamber 121. Some of the leaking processed material is removed as a result of being fed backward by the separation wind. Processed material containing a large proportion of grain is received on the upper face of the grain sieve 140, and straw or the liked contained in this processed material is removed as a result of being fed backward on the upper face of the grain sieve case 140. However, depending on the quantity of reaped grain culms fed to the threshing apparatus 101 and parameters for setting the capability of each part of the threshing unit 141 and the separation unit 142 (e.g., the aforementioned air volume of the separation wind, the degree of opening of the chaff lips 138A etc.), grain that has not been sufficiently processed into simple grain and straw or the like (hereinafter referred to as “foreign matter”) reach the first primary-material collection conveyor 129 via the primary-material guide 162 in some cases. In such cases, the foreign matter is stored in the grain tank 112.

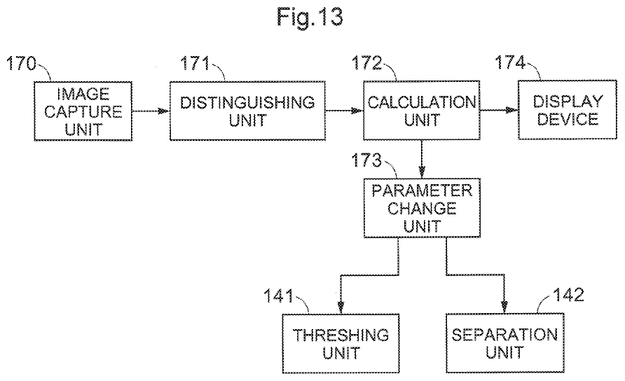

Such foreign matter reduces the degree of separation (or separation efficiency) of the threshing apparatus 101, and it is therefore favorable that the amount of foreign matter conveyed to the grain tank 112 is smaller. The combine 120 of the present embodiment is capable of determining the amount of foreign matter conveyed to the grain tank 112 and reducing the amount of foreign matter conveyed to the grain tank 112. The determination and reduction of foreign matter will be described below with reference to FIG. 13.

To realize the above functions, the combine 120 has an image capture unit 170 for acquiring a captured image 100G of the inside of the conveying path through which separated material is conveyed from the separation unit 142 to the grain tank 112. Separated material is grain separated by the shaking separator 124. The separated material is collected by the primary-material collecting section 126 and conveyed through the primary-material collection conveyor 129 to the grain tank 112.

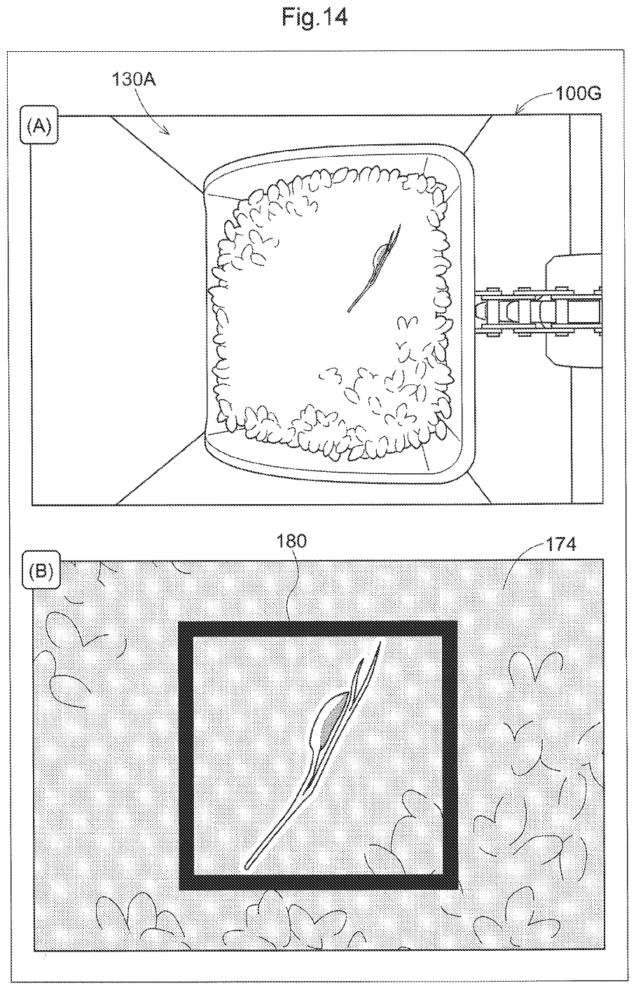

Accordingly, the conveying path corresponds to a path through which separated material is conveyed from the primary-material collecting section 126 to the grain tank 112. The image capture unit 170 is arranged in at least one location in the conveying path and acquires a captured image 100G of the inside of the conveying path. Primary material conveyed by the primary-material collection conveyor 129 in the present embodiment is conveyed rightward by the storage screw 130 and fed to the grain tank 112, as mentioned above. The image capture unit 170 captures an image of a conveyance terminal section 130A of the bucket conveyor of the primary-material collection conveyor 129. The image capture unit 170 is thus capable of acquiring the captured image 100G that includes separated material fed to the grain tank 112. FIG. 14(A) shows an example of the captured image 100G. The image capture unit 170 may of course be provided in the primary-material collecting section 126 instead of or in addition to the conveyance terminal section 130A, or may be provided on the conveying path in the storage screw 130.

The image capture unit 170 may be a known camera, for example. If the amount of light in the conveying path is not sufficient for acquiring the captured image 100G, a night vision camera may be used, or a light source (e.g., flash) that emits light every time a captured image 100G is acquired may be used. In this case, light may be sequentially emitted from different directions in time series such that the image capture unit 170 can easily capture an image. The captured image 100G acquired by the image capture unit 170 is transmitted to a later-described distinguishing unit 171.

The distinguishing unit 171 distinguishes separated material included in the captured image 100G into normal grain that meets a predetermined quality and foreign matter other than the normal grain that mixes in the separated material, by means of image analysis. The captured image 100G that includes separated material is transmitted from the image capture unit 170, as mentioned above. Here, there are cases where the aforementioned separated material conveyed from the separation unit 142 to the grain tank 112 contains not only grain but also foreign substances such as straw, damaged material that is partially damaged or chipped, dirty grain with a dirty surface, rachis branches including branching spikes, hollow bran, and grain with a hair-like awn, for example. The normal grain that meets the predetermined quality in the present embodiment refers to grain obtained by appropriately threshing reaped grain culms. Material other than the aforementioned foreign substance, damaged material, dirty grain, rachis branches, bran, and grain with an awn is referred to as normal grain. Foreign substances, damaged material, dirty grain, rachis branches, bran, and grain with an awn are referred to as foreign matter. The distinguishing unit 171 analyzes the captured image 100G transmitted from the image capture unit 170 and distinguishes between normal grain and foreign matter.

The distinguishing unit 171 in the present embodiment performs the distinction by inputting image data generated based on the captured image 100G to a neural network that is trained to distinguish normal grain in separated material. The distinguishing unit 171 first generates image data to be used in the aforementioned distinction, based on the captured image 100G transmitted from the image capture unit 170. This image data is for allowing the neural network to easily recognize images. Specifically, the distinguishing unit 171 generates image data by removing noise, distortion, or the like included in the captured image 100G, enhancing edges of each object (separated material in the present embodiment) included in the captured image 100G, and adjusting the brightness and color. At this time, the distinguishing unit 171 may generate image data by trimming the object. The distinguishing unit 171 inputs the thus-generated image data to the neural network.

Here, the neural network is an algorithm that simulates the human brain and is executed by a computer. For example, if the aforementioned image data is input, the neural network outputs the results of distinguishing between normal grain and foreign matter as results similar to those obtained through distinction made by the human brain. The neural network used in the present embodiment is trained, in advance, to be capable of distinguishing between normal grain and foreign matter.

Specifically, the neural network used in the present embodiment is trained to output the distinction results indicating that separated material contains normal grain if image data for training generated based on a captured image G that includes normal grain is input as training data to the neural network. Also, the neural network is trained to output the distinction results indicating that separated material contains foreign matter if image data for training generated based on a captured image 100G that includes foreign matter is input as training data to the neural network.

That is, the neural network is given, in advance, image data for training generated based on a captured image data 100G that includes normal grain and a label, as well as image data for training generated based on a captured image 100G that includes foreign matter and a label, in order to cause the neural network to learn features of image data for each label before image data generated based on the aforementioned captured image 100G is input to the neural network. At this time, it is favorable to train the neural network by giving image data for training on each type of foreign matter.

Thus, it is possible to easily distinguish whether separated material included in the captured image 100G transmitted from the image capture unit 170 is normal grain or foreign matter. Note that this learning may be performed continuously without training data at the time of actually distinguishing separated material using the captured image 100G transmitted from the image capture unit 170 in the combine 120. The distinguishing unit 171 thus distinguishes whether separated material included in the captured image 100G is normal grain or foreign matter with use of the neural network.

The combine 120 may also have a configuration in which a calculation unit 172 calculates the ratio between normal grain and foreign matter in separated material included in the captured image 100G, based on the results of distinction by the distinguishing unit 171. That is, the distinguishing unit 171 distinguishes separated material included in the captured image 100G into normal grain and foreign matter, and it is favorable that the calculation unit 172 calculates the proportions of the quantity of normal grain and the amount of foreign matter to the quantity of separated material included in the captured image 100G. The calculation unit 172 may of course simply calculate the ratio between the quantity of normal grain and the amount of foreign matter.

In this case, the aforementioned learning may be such that the neural network learns features of image data for each label by giving image data for training generated based on a captured image 100G that only includes normal grain and a label (the ratio between normal grain and foreign matter is 100:0), and image data for training generated based on a captured image 100G that includes normal grain and foreign matter at a predetermined ratio and a label (the ratio between normal grain and foreign matter is 100-N: N (here, N is a number no less than 0 and less than 100). It is thereby possible to calculate the ratio between normal grain and foreign matter with use of the neural network. In this case, the calculation unit 172 is integrated with the distinguishing unit 171. Note that N may be, for example, a multiple of a predetermined number (e.g., a multiple of 5 or 10).

For example, an operator of the cabin 110 is able to understand whether separated material conveyed to the grain tank 112 is adequate by displaying the ratio between normal grain and foreign matter calculated by the calculation unit 172 on a display device 174 (e.g., a display screen of a terminal) provided in the cabin 110. For example, if the proportion of foreign matter is higher than that of normal grain, the operator is able to reduce the ratio of foreign matter by changing threshing parameters with which the threshing capability of the threshing unit 141 is settable and/or separation parameters with which the separation capability of the separation unit 142 is settable in such a manner as to reduce the proportion of foreign matter.

Here, the threshing parameters with which the threshing capability of the threshing unit 141 is settable correspond to a set value for setting the rotational speed of the rotating support shaft 155 of the threshing cylinder 122 or a set value for setting the angle at which the dust feed valves 153a are attached to the top plate 153. The separation parameters with which the separation capability of the separation unit 142 is settable correspond to a set value for setting the air volume of the separation wind from the winnower 125, a set value for setting the degree of opening of the chaff lips 138A, and set values for setting the shaking speed and the shaking amount of the shake-drive mechanism 143 that shakes the shaking separator 124. The operator is able to change those various set values to reduce the proportion of foreign matter and increase the proportion of normal grain.

The above set values may also be changed automatically. In this case, the combine 120 may include a parameter change unit 173 for changing the threshing parameters with which the threshing capability of the threshing unit 141 is settable and the separation parameters with which the separation capability of the separation unit is settable, in accordance with the ratio between normal grain and foreign matter. This configuration enables the degree of separation to be improved by the parameter change unit 173 changing the set value for setting the rotational speed of the rotating support shaft 155 of the threshing cylinder 122, the set value for setting the angle at which the dust feed valves 153a are attached to the top plate 153, the set value for setting the air volume of the separation wind from the winnower 125, the set value for setting the degree of opening of the chaff lips 138A, and the set values for setting the shaking speed and the shaking amount of the shake-drive mechanism 143 that shakes the shaking separator 124 in such a manner as to reduce the proportion of foreign matter and increase the proportion of normal grain.

It is, of course, possible to display advice indicating set values to be changed to reduce the proportion of foreign matter and increase the proportion of normal grain on the display device 174, instead of the parameter change unit 173 automatically changing the set values. The operator is able to improve the degree of separation by changing the set values based on the advice.

If changing the set values does not reduce the proportion of foreign matter or increase the proportion of normal grain, a notification may be given to the operator with use of the display device 174 and/or a speaker. Further, if the combine 120 is automatically traveling, the automatic travel may be stopped. In this case, the notification may be given for each type of foreign matter, and the automatic travel may be stopped. That is, the notification may be given and the automatic travel may be stopped only if the proportion of foreign substances is large.

The captured image 100G may also be displayed on the display device 174. In this case, foreign substances, damaged material, dirty grain, rachis branches, bran, grain with an awn, and the like are each marked and clearly indicated to the operator, based on the results of distinction by the distinguishing unit 171. For example, rachis branches in the captured image 100G may be displayed while being surrounded by a frame 180 having a predetermined shape or painted in a certain color in a display screen of the display device 174, as shown in FIG. 14(B). This marking may be given separately to foreign substances, damaged material, dirty grain, rachis branches, bran, and grain with an awn, using different colors. Note that this clear indication may be performed upon the image capture unit 170 acquiring the captured image 100G, or may be performed by displaying the captured image 100G on the display device 174 after a predetermined time has elapsed since the acquisition of the captured image 100G.

In summary, the shaking separator 124 separates grain as separated material from processed material, and the combine 120 is capable of changing the separation amount by which grain is separated as separated material, in accordance with the results of distinction by the distinguishing unit 171. Specifically, the degree of opening of the chaff lips 138A may be reduced as the quantity of foreign substances increases. That is, the chaff lips 138A are brought closer to parallel to the vertical direction as the quantity of foreign substances increases. This configuration increases the amount of primary material separated by the first chaff sieve 138, and makes it possible to regulate the quantity of foreign substances leaking down from the first chaff sieve 138.

It is favorable to increase the air volume of the separation wind from the winnower 125 as the quantity of foreign substances or bran increases, such that the foreign substance and bran are removed by the first chaff sieve 138 and the grain sieve 140. This configuration improves the capability of the first chaff sieve 138 and the grain sieve 140 to remove foreign substances and bran, and makes it possible to reduce the quantity of foreign substances and bran mixing in the primary-material collecting section 126 even if the degree of opening of the chaff lips 138A is increased.

A configuration is favorable in which, the larger the quantity of rachis branches, the amount of crop fed in the body 160 is reduced by reducing the rotational speed of the rotating support shaft 155 of the threshing cylinder 122 and/or controlling the inclination of the dust feed valves 153a with respect to the front-back direction. Meanwhile, a configuration is also preferable in which, if the amount of damaged material and/or dirty grain is large, the amount of crop fed in the body 160 is increased by increasing the rotational speed of the rotating support shaft 155 of the threshing cylinder 122 and/or controlling the inclination of the dust feed valves 153a with respect to the front-back direction.

In addition, grain stored in the grain tank 112 is dried (post-harvested) by a dryer. If a large quantity of foreign substances mixes in the grain, the dryer is likely to jam, and it becomes difficult to dry the grain. Grain can be appropriately dried by recording the results of distinction by the distinguishing unit 171, in particular the proportion of foreign substances, and removing the foreign substances with use of a rougher and/or changing drying conditions for the drier before the grain is dried by the drier, based on the record.

Note that, as for the aforementioned control, both the degree of opening of the chaff lips 138A and the air volume of the separation wind from the winnower 125 may be changed. Specifically, for example, the degree of opening of the chaff lips 138A may be increased, and the air volume of the separation wind from the winnower 125 may also be increased in accordance with the distinction results. Also, the degree of opening of the chaff lips 138A may be reduced, and the air volume of the separation wind from the winnower 125 may also be reduced.

As described above, the threshing capability of the threshing unit 141 and the separation capability of the separation unit 142 are controlled in accordance with the results of distinction by the distinguishing unit 171 in the combine 120. In other words, the threshing amount of the threshing unit 141 (threshing capability of the threshing unit 141) and the separation amount of the separation unit 142 (separation capability of the separation unit 142) are feedback-controlled based on the results of distinction by the distinguishing unit 171. Therefore, the degree of opening of the chaff lips 138A, the air volume of the separation wind from the winnower 125, the inclination of the dust feed valves 153a with respect to the front-back direction, and the traveling speed of the traveling body 117 correspond to gain adjustment parameters in the feedback control.

As described above, the combine 120 is capable of suppressing degradation of the threshing function and the separation function.

### Other Embodiments

Although the above embodiment takes a normal combine as an example of the combine 120, the combine 120 may alternatively be a head-feeding combine. Further, the combine 120 may alternatively be a combine with wheel-type traveling devices instead of the crawler traveling devices 103.

In the above embodiment, foreign substances, damaged material, dirty grain, rachis branches, bran, and grain with an awn are referred to as foreign matter. However, some of them (e.g., dirty grain and grain with an awn) may alternatively be dealt with as normal grain.

In the above embodiment, the calculation unit 172 calculates the ratio between normal grain and foreign matter. However, the calculation unit 172 may also calculate the proportion of each type of foreign matter. In other words, the calculation unit 172 may also calculate the proportion of foreign substances, the proportion of damaged material, the proportion of dirty grain, the proportion of rachis branches, and the proportion of bran, to separated material included in the captured image G. The proportion of damaged material and dirty grain may also be calculated as a single category without distinction therebetween.

In the above embodiment, the calculation unit 172 calculates the ratio between normal grain and foreign matter in separated material included in the captured image 100G based on the results of distinction by the distinguishing unit 171. However, the combine 120 need not necessarily have the calculation unit 172. That is, the distinguishing unit 171 may only distinguish separated material into normal grain and foreign matter, and may further transmit the distinction results to other devices.

In the above embodiment, the parameter change unit 173 changes the threshing parameters with which the threshing capability of the threshing unit 141 is settable and the separation parameters with which the separation capability of the separation unit 142 is settable in accordance with the ratio between normal grain and foreign matter. However, the combine 120 need not have the parameter change unit 173. In this case, the operator may be notified of advice on the threshing parameters and/or the separation parameters that are to be preferably changed, as mentioned above.

In the above embodiment, the distinguishing unit 171 performs the distinction by inputting image data generated based on the captured image 100G to the neural network that is trained to distinguish normal grain in separated material. However, the distinguishing unit 171 may distinguish normal grain from foreign matter in separated material without use of a neural network.

Although the above embodiment has described the combine 120, processing performed by the functional parts of the above embodiment may also be adopted as a grain inspection method. In this case, the grain inspection method may include: a threshing step of threshing reaped grain culms and discharging threshed material from a threshing unit 141; a separation step of separating grain as separated material from the discharged threshed material, with use of a separation unit 142; a storing step of storing, in a grain tank 112, the conveyed separated material; an image capture step of acquiring a captured image 100G of the inside of a conveying path through which the separated material is conveyable from the separation unit 142 to the grain tank 112; and a distinction step of distinguishing, by means of image analysis, separated material included in the captured image 100G into normal grain that meets a predetermined quality and foreign matter other than the normal grain, the foreign matter being mixed in the separated material.

Although the above embodiment has described the combine 120, processing performed by the functional parts of the above embodiment may also be adopted as a grain inspection system. In this case, the grain inspection system may include: a threshing unit 141 configured to thresh reaped grain culms and discharge threshed material; a separation unit 142 configured to separate grain as separated material from the discharged threshed material; a grain tank 112 in which the separated grain conveyed thereto is storable; an image capture unit 170 configured to acquire a captured image 100G of the inside of a conveying path through which the separated material is conveyable from the separation unit 142 to the grain tank 112; and a distinguishing unit 171 configured to distinguish, by means of image analysis, separated material included in the captured image 100G into normal grain that meets a predetermined quality and foreign matter other than the normal grain, the foreign matter being mixed in the separated material.

The functional parts of the above embodiment may also be adopted as a grain inspection program. In this case, the grain inspection program may cause a computer to implement: a threshing function of threshing reaped grain culms and discharging threshed material from a threshing unit 141; a separation function of separating grain as separated material from the discharged threshed material, with use of a separation unit 142; a storing function of storing, in a grain tank 112, the conveyed separated material; an image capture function of acquiring a captured image 100G by capturing an image of the inside of a conveying path through which the separated material is conveyable from the separation unit 142 to the grain tank 112; and a distinction function of distinguishing, by means of image analysis, separated material included in the captured image 100G into normal grain that meets a predetermined quality and foreign matter other than the normal grain, the foreign matter being mixed in the separated material.

Further, this grain separation program may also be recorded in a recording medium.

### Third Embodiment

### Overall Configuration of Combine

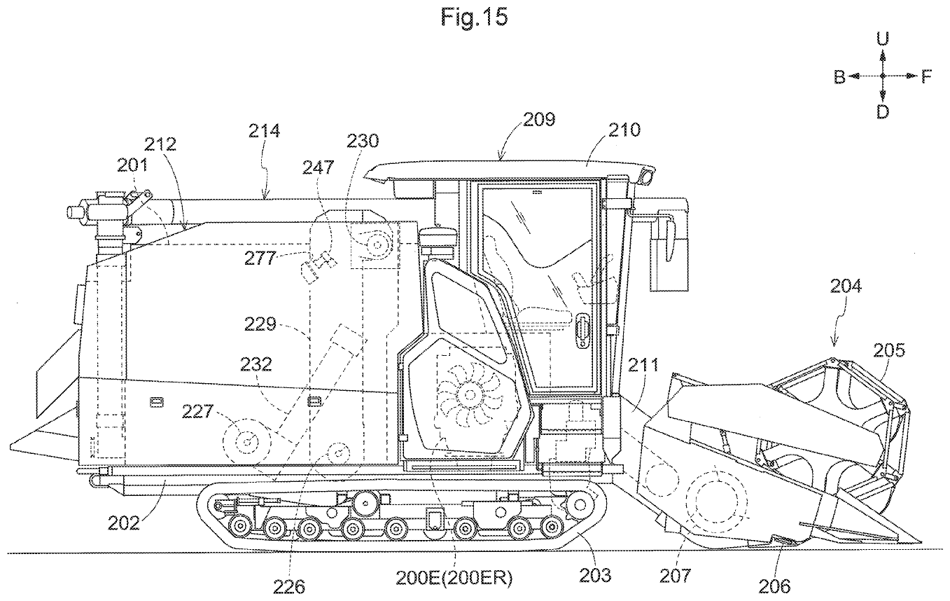

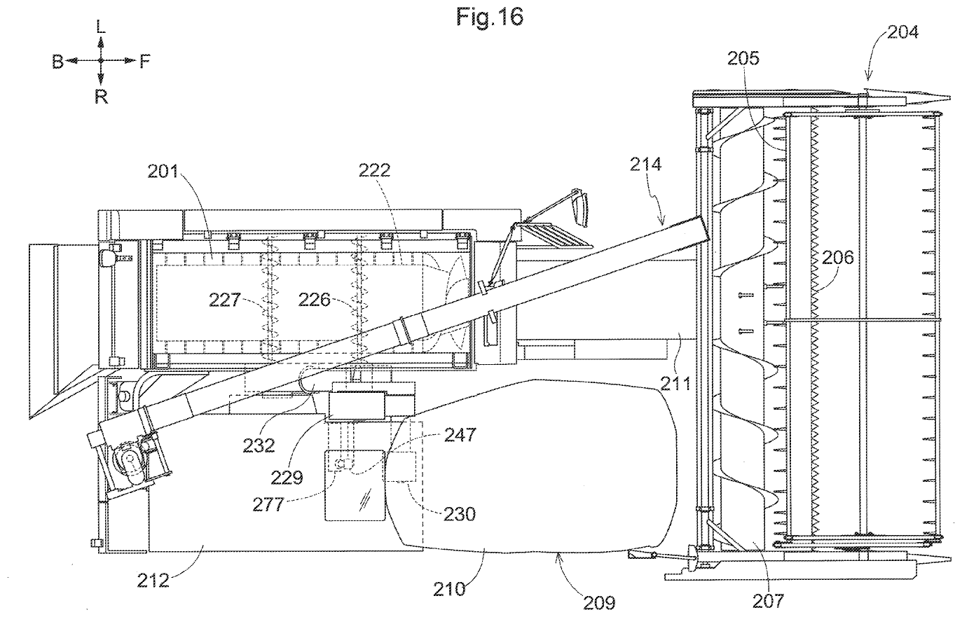

First, a schematic configuration of a combine according to the present embodiment will be described with reference to FIGS. 15 and 16. The following description will take a normal combine as an example of the combine.

In the present embodiment, “front” (the direction of F arrow in FIG. 15) means the front in the front-back direction (travel direction) of the body of the combine, and “back” (the direction of B arrow in FIG. 15) means the back in the front-back direction of the body of the combine to facilitate understanding, unless stated otherwise. “Upper/above” (the direction of U arrow in FIG. 15) and “lower/below” (the direction of D arrow in FIG. 15) refer to positional relationships in the vertical direction of the body of the combine, and indicate relationships in terms of the ground height. The “left-right direction” and the “lateral direction” mean the transverse direction of the body of the combine (widthwise direction of the body of the combine) perpendicular to the front-back direction of the body of the combine. In other words, “left” (the direction of L arrow in FIG. 16) and “right” (the direction of arrow R in FIG. 16) respectively mean the leftward and rightward directions of the body of the combine.

The combine has crawler traveling devices 203, a body frame 202 supported by the traveling devices 203, a reaper 204 for reaping a crop (any of various crops such rice, wheat, soybean, and rapeseed) in a field, a feeder 211, a threshing apparatus 201, a grain tank 212, and a grain unloader 214.

The reaper 204 includes a raking reel 205 for raking the crop, a clipper-type cutter 206 for cutting the crop in the field, and an auger 207 for horizontally feeding the reaped crop to the feeder 211. The crop reaped by the reaper 204 is conveyed to the threshing apparatus 201 by the feeder 211, and threshed and separated by the threshing apparatus 201. The separated material that has been threshed and separated by the threshing apparatus 201 is stored in the grain tank 212, and is discharged, as appropriate, to the outside of the combine by the grain unloader 214. Although not specifically shown in the figure, the grain tank 212 is provided with a contact-type full sensor at a high position therein. Upon the grain tank 212 becoming full, the full sensor detects that the grain tank 212 is full due to separated material coming into contact with the full sensor.

The combine has a cab 209 located to the right and rearward of the reaper 204 and adjacent to the feeder 211. The cab 209 is covered by a cabin 210. The combine has an engine compartment 200ER below the cab 209. The engine compartment 200ER accommodates an engine 200E, as well as a cooling fan, a radiator, and the like, which are not particularly shown in the figure. Motive power of the engine 200E is transmitted to work machines, such as the traveling devices 203, the reaper 204, and the threshing unit 201, by a motive power transmission mechanism (not shown).

Threshing Apparatus

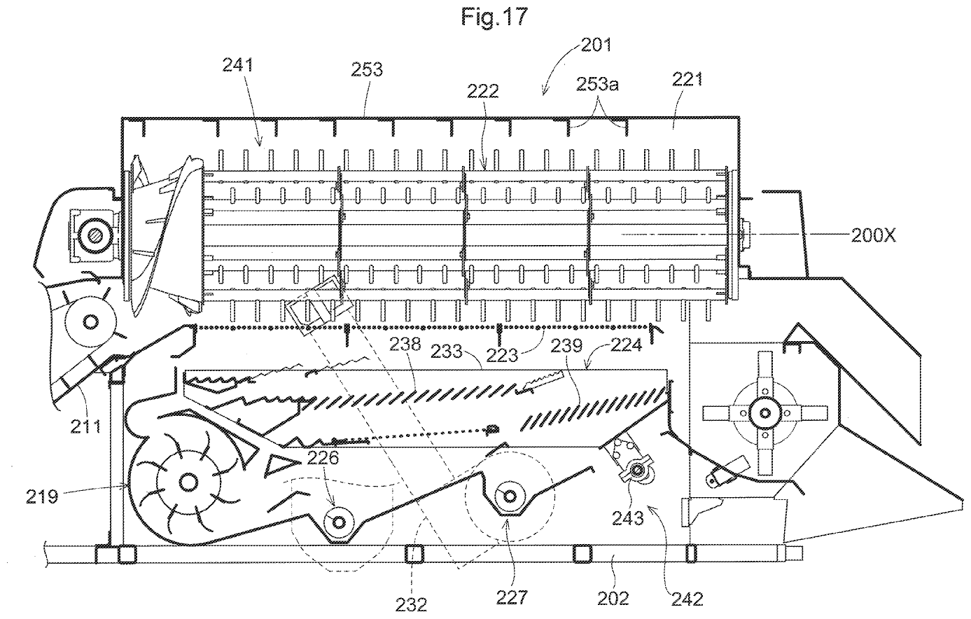

Next, a configuration of the threshing apparatus 201 will be described with reference to FIG. 17. The threshing apparatus 201 includes a threshing section 241 for threshing the crop with use of a threshing cylinder 222, and a separation section 242 for shaking and separating threshed material. The threshing section 241 is arranged in an upper region of the threshing apparatus 201. A receiving net 223 is located below the threshing section 241. The separation section 242 is located below the receiving net 223. The separation section 242 separates threshed material leaking down from the receiving net 223 into separated material that contains grain to be collected, and material to be discharged, such as waste straw.

The threshing section 241 has a threshing chamber 221 surrounded by left and right side walls, a top plate 253, and the receiving net 223 of the threshing apparatus 201. The threshing chamber 221 includes the threshing cylinder 222 that rotates to thresh the crop, and a plurality of dust feed valves 253a. The crop conveyed by the feeder 211 is put into the threshing chamber 221 and threshed by the threshing cylinder 222. The crop rotated together with the threshing cylinder 222 is transferred backward by a feeding effect of the dust feed valves 253a.

The dust feed valves 253a each have a plate shape, and are located on an inner face (lower face) of the top plate 253 at predetermined spacing in the front-back direction. The dust feed valves 253a are inclined with respect to a rotation axis 200X in a plan view. For this reason, each dust feed valve 253a exerts a force that moves backward the reaped grain culms rotating together with the threshing cylinder 222 in the threshing chamber 221. The inclination angle of the dust feed valves 253a with respect to the rotation axis 200X is adjustable. The speed of feeding the crop backward in the threshing cylinder 222 is determined by the inclination angle of the dust feed valves 253a. The threshing efficiency of threshing the crop is also affected by the speed of feeding the crop in the threshing cylinder 222. As a result, the processing capability for threshing the crop is adjustable with various means, which include changing of the inclination angle of the dust feed valves 253a. Although not specifically shown the figure, a dust feed valve control mechanism capable of changing the inclination of the dust feed valves 253a is provided such that the inclination angle of the dust feed valves 253a is automatically adjustable.

The separation section 242 includes a shaking separator 224 having a sieve case 233, a winnower 219, a primary-material collecting section 226, a secondary-material collecting section 227, and a secondary-material returner 232.

The winnower 219 is located in a front lower region of the separation section 242, and generates a rearward separation wind from the front side of the shaking separator 224 in the direction in which processed material is conveyed. The separation wind has an effect of feeding relatively lightweight waste straw or the like backward of the sieve case 233. In the shaking separator 224, threshed material in the sieve case 233 is shaken and separated while being transferred backward due to a shake-drive mechanism 243 shaking the sieve case 233. For this reason, the upstream side of the shaking separator 224 in the direction in which processed material is conveyed will be referred to as a front end or a front side, and the downstream side will be referred to as a rear end or rear side in the following description. Note that the intensity (air volume, wind speed) of the separation wind of the winnower 219 is changeable. A stronger separation wind facilitates the backward feeding of threshed material and increases the separation speed. Conversely, a weaker separation wind makes threshed material stay longer in the sieve case 233 and increases the separation accuracy. It is therefore possible to adjust the separation efficiency (separation accuracy and separation speed) of the shaking separator 224 by changing the intensity of the separation wind of the winnower 219. Although not specifically shown in the figure, a winnower control mechanism capable of changing the intensity of the separation wind of the winnower 219 is provided such that the intensity of the separation wind of the winnower 219 is automatically changeable.

The sieve case 233 has a first chaff sieve 238 in its front half, and a second chaff sieve 239 in its rear half. In addition to the first chaff sieve 238 and so on, the sieve case 233 also has a grain pan and a grain sieve, which are general components and are therefore not specifically described. Threshed material leaking down from the receiving net 223 falls onto the first chaff sieve 238 and the second chaff sieve 239. Most of the threshed material leaks down from the receiving net 223 to the front half of the sieve case 233 including the first chaff sieve 238, and is separated, first roughly and then precisely, by the front half of the sieve case 233. Some of the threshed material leaks down from the receiving net 223 to the second chaff sieve 239, or does not leak down to the first chaff sieve 238 but is transferred to the second chaff sieve 239, and is separated by the second chaff sieve 239.

The primary-material collecting section 226 having a screw is located below the front half of the sieve case 233, and the secondary-material collecting section 227 having a screw is located below the rear half of the sieve case 233. Primary material (“separated material” in the present invention) that has been separated and has leaked down in the front half of the sieve case 233 is collected by the primary-material collecting section 226 and conveyed toward the grain tank 212 (rightward in the left-right direction of the body of the combine). Secondary material (which is generally separated with low precision and contains a high proportion of cut straw or the like) that has been separated and has leaked down in the rear half (second chaff sieve 239) of the sieve case 233 is collected by the secondary-material collecting section 227. The secondary material collected by the secondary-material collecting section 227 is returned to the front part of the separation section 242 by the secondary-material returner 232 and re-separated by the sieve case 233.

The first chaff sieve 238 includes a plurality of plate-like chaff lips arranged in the transfer direction (front-back direction). Each chaff lip is inclined with its rear end raised obliquely upward. The inclination angle of the chaff lips is variable. The steeper the inclination angle is, the wider the spacing between adjacent chaff lips is, and the more easily threshed material leaks down. For this reason, the separation efficiency (separation accuracy and separation speed) of the shaking separator 224 is adjustable by adjusting the inclination angle of the chaff lips. A lip control mechanism capable of changing the inclination of the chaff lips is provided such that the inclination angle of the chaff lips is automatically changeable.

The second chaff sieve 239 also has the same configuration as the first chaff sieve 238. An angle control mechanism capable of changing the inclination of chaff lips of the second chaff sieve 239 is also provided such that the inclination of the chaff lips is automatically changeable.

Conveying Apparatus

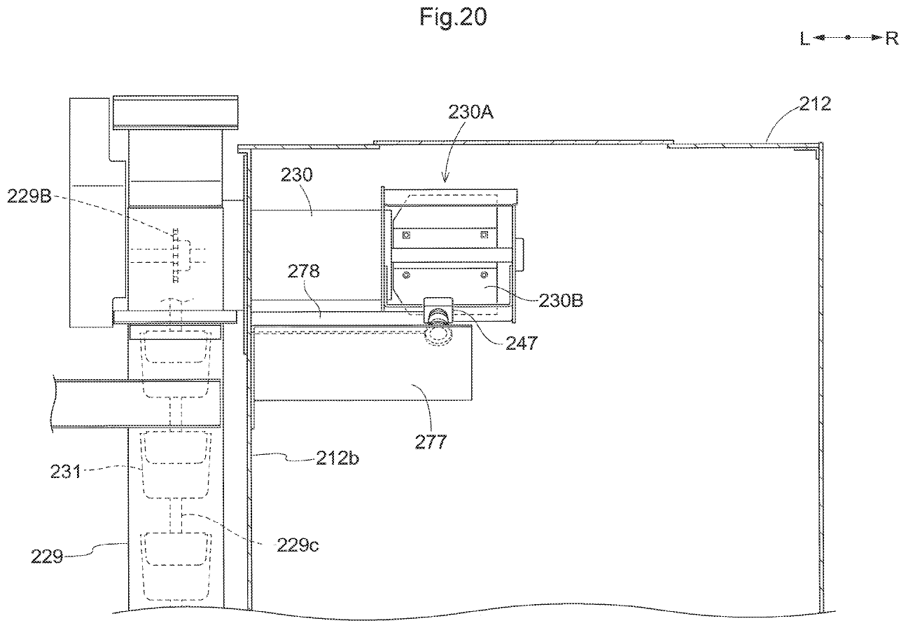

The combine has a grain elevator 229 that conveys separated material collected by the primary-material collecting section 226 to the grain tank 212, as shown in FIGS. 15 and 20. The grain elevator 229 is arranged between the threshing apparatus 201 and the grain tank 212, and stands in the vertical direction. The grain elevator 229 is constituted by a bucket conveyor. Separated material lifted by the grain elevator 229 is delivered to a lateral-feed conveying device 230 at an upper end of the grain elevator 229. The lateral-feed conveying device 230 has a screw and is inserted into the grain tank 212 from a front left wall thereof. The lateral-feed conveying device 230 has a grain releasing device 230A at an end on the inner side of the tank. The grain releasing device 230A has a plate-like releasing rotator 230B, which integrally rotates together with the screw. Separated material is laterally fed by the lateral-feed conveying device 230 and ultimately thrown into the grain tank 212 by the grain releasing device 230A.

The grain elevator 229 has a plurality of buckets 231 that are attached at regular spacing to the outer side of an endless rotating chain 229C wound around a driving sprocket (not shown) located at a lower end and a driven sprocket 229B.

The grain elevator 229 and the lateral-feed conveying device 230 correspond to a “conveying apparatus” of the present invention.

Grain Distinguishing Device

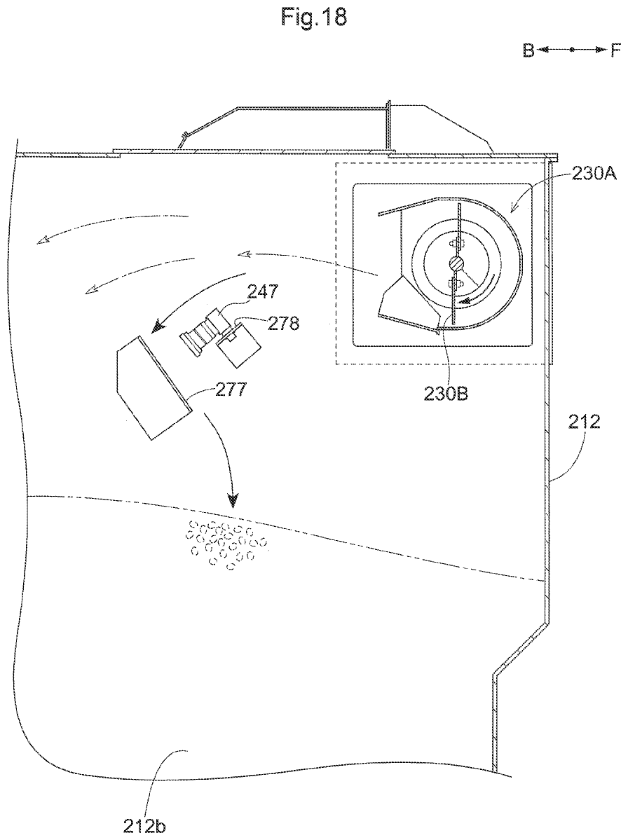

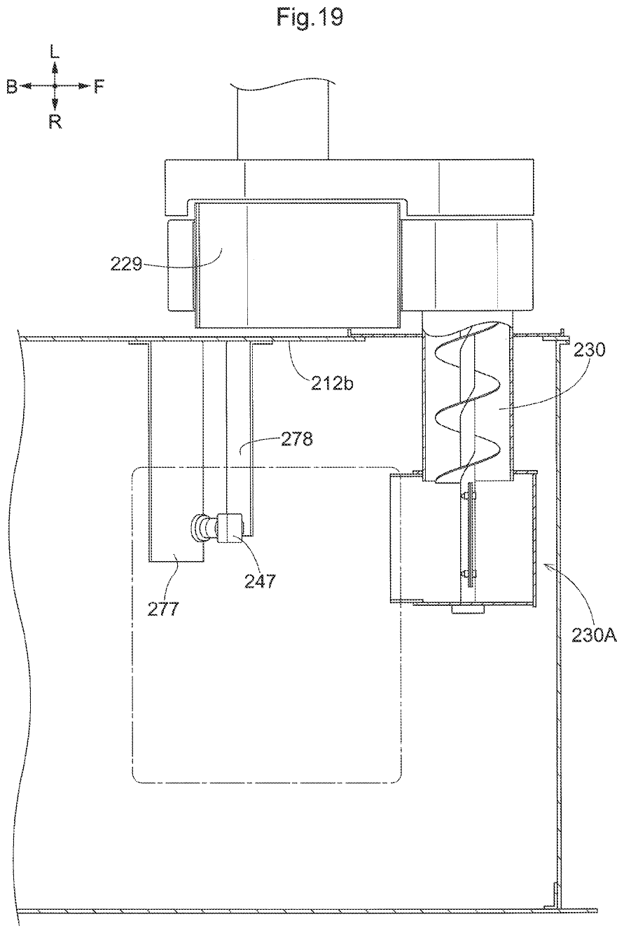

Next, an example configuration of a grain distinguishing device having an inclined section 277 will be described with reference to FIGS. 18 to 20.

The grain distinguishing device has an inclined section 277 and an image capture unit 247. The inclined section 277 is a plate-like member supported in a cantilevered manner by a left wall 212b of the grain tank 212, and is located behind the grain releasing device 230A. The inclined section 277 extends from the left wall 212b toward the inside of the grain tank 212, and partially overlaps the grain releasing device 230A in a back view. An upper face of the inclined section 277 is inclined with a lowered front portion in such a manner as to face the grain releasing device 230A.

The grain releasing device 230A throws separated material such that the thrown separated material flies over the image capture unit 247 and falls onto the inclined section 277.

This configuration makes at least some of the separated material thrown by the grain releasing device 230A fall onto the upper face of the inclined section 277 only from above in a widely dispersed state. The separated material falling onto the inclined section 277 is received by the upper face of the inclined section 277, slides down and forward in a widely-dispersed state from an upper part of the inclined section 277 to a lower part of the inclined section 277, and then flows down to the bottom of the grain tank 212.

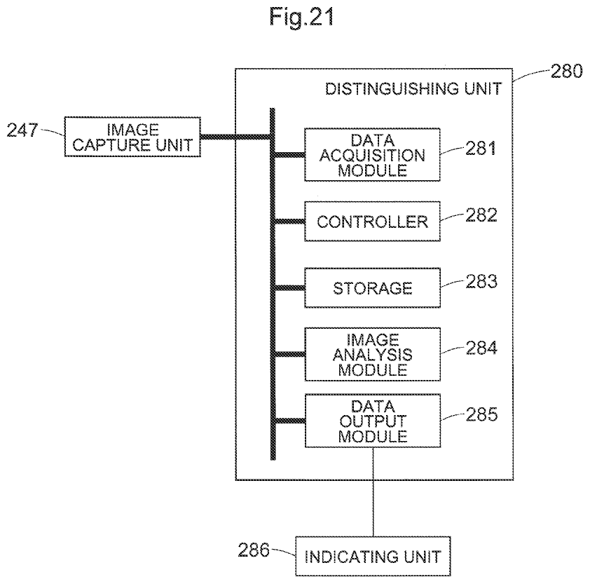

The image capture unit 247 captures an image of the separated material sliding down along the upper face of the inclined section 277. The image capture unit 247 is located close to the inclined section 277 with the back of the image capture unit 247 facing the grain unloader 230A, between grain releasing device 230A and the inclined section 277. The image capture unit 247 is supported by a stay 278 that protrudes from the left wall 212b of the grain tank 212 toward the inside of the grain tank 212. The image capture unit 247 is disposed opposing (in the direct front of) the inclined section 277, with a lens facing the upper face of the inclined section 277. In other words, the optical axis of the lens of the image capture unit 247 intersects the upper face of the inclined section 277 perpendicularly or substantially perpendicularly. The image capture unit 247 captures an image of the separated material flowing down on the upper face of the inclined section 277. The captured image is sent to a later-described distinguishing unit 280 (see FIG. 21).

The inclined section 277 and the image capture unit 247 are located at positions higher than the aforementioned full sensor. This configuration enables the image capture unit 247 to captures images for a long time until the grain tank 212 becomes full and to captures images for a greater number of times.

Grain Distinction

As mentioned above, the image capture unit 247 captures an image of separated material that is being conveyed. The captured image is analyzed, and normal grain (unhulled grain) contained in the separated material is distinguished from other foreign matter. Examples of the foreign matter include foreign substances such as waste straw, bran (empty hulls), rachis branches, damaged grain, and spotted dirty grain. A configuration for distinguishing separated material will be described below with reference to FIG. 21.

The distinguishing unit 280 distinguishes separated material. The distinguishing unit 280 has a data acquisition module 281, a controller 282, a storage 283, an image analysis module 284, and a data output module 285, which can send and receive data to and from each other via a bus or a LAN. The distinguishing unit 280 is communicably connected to the aforementioned image capture unit 247, acquires a captured image by capturing an image of separated material, and gives an image capture instruction to the image capture unit 247.

The controller 282 controls the operation of the data acquisition module 281, the controller 282, the storage 283, the image analysis module 284, and the data output module 285. The controller 282 includes a processor such as an ECU or a CPU. The controller 282 may be operated by hardware, or may be operated by the processor executing a program. In this case, the program is stored in the later-described storage 283. Further, the controller 282 controls the operation of the image capture unit 247.

The data acquisition module 281 acquires a captured image by capturing an image of separated material that is sent by the image capture unit 247 and sends the acquired captured image to the storage 283, in response to control by the controller 282.

The storage 283 stores the captured image sent from the data acquisition module 281, and stores the analysis results sent from the later-described image analysis module 284.

The image analysis module 284 acquires the captured image stored in the storage 283, analyzes the image, distinguishes between normal grain and foreign matter other than the normal grain in the separated material, and calculates the proportion of the foreign matter to the separated material, in response to control by the controller 282. The image analysis module 284 transmits, to the storage 283, the distinction results and the calculated proportion of the foreign matter as the analysis results. Examples of the foreign matter include foreign substances, damaged grain, dirty grain, rachis branches, and bran. Note that the image analysis module 284 may distinguish between normal grain and foreign matter, but may optionally distinguish between normal grain and at least one of the specific types of abnormality including foreign substances, damaged grain, dirty grain, rachis branches, and bran, and calculate the proportions of the normal grain and this specific type of abnormality.

The image analysis module 284 acquires learned data that is stored in advance in the storage 283, and analyzes the captured image received from the storage 283 by inputting the image to the learned data. The learned data is for a neural network or the like trained by machine learning by inputting, to artificial intelligence (AI), a plurality of sample images (which correspond to “images”) as input data and information indicating whether or not each of the sample images is an image of foreign matter as training data.

The data output module 285 acquires the analysis results stored in the storage 283 and outputs the acquired analysis results to the outside of the distinguishing unit 280, in response to control by the controller 282.

Further, the distinguishing unit 280 is communicably connected to an indicating unit 286.

The indicating unit 286 receives the analysis results sent from the data output module 285 of the distinguishing unit 280 and displays information corresponding to the analysis results. The indicating unit 286 may be a display, a lamp, a speaker, or the like.

If, for example, the indicating unit 286 is a display, the indicating unit 286 is capable of displaying images captured by the image capture unit 247 and information representing the proportion of foreign matter and/or the proportion of each specific type of abnormality with text or graphs. If the indicating unit 286 is a lamp or a speaker, it is possible to change the lighting state of the lamp or a sound generated from the speaker in accordance with the proportion of foreign matter and/or the proportion of each specific type of abnormality, and turn on a warning lamp or cause the speaker to generate a warning sound if the proportion of foreign matter and/or the proportion of each specific type of abnormality is greater than a predetermined value.

With the indicating unit 286 indicating information corresponding to the analysis results, an operator is able to estimate the separation accuracy of the separation section 242 and the threshing accuracy of the threshing section 241 by visually recognizing foreign matter contained in separated material and/or checking the proportion of foreign matter. The operator is then able to operate the dust feed valve control mechanism, the winnower control mechanism, and the lip control mechanism in accordance with the estimation results to adjust the inclination angle of the dust feed valves 253a, the intensity of the separation wind of the winnower 219, and the inclination angles of the chaff lips of the first chaff sieve 238 and the second chaff sieve 239, thereby bringing the separation accuracy of the separation section 242 and the threshing accuracy of the threshing section 241 to an appropriate state. Since the yield of crop per hour varies as a result of changing the traveling speed, the traveling speed may be changed in accordance with the estimation results.

Variations

(1) The layout of the inclined section 277 and the image capture unit 247 is not limited to the positional relationship of the above embodiment. The position of the grain releasing device 230A is changeable as appropriate, as per the throwing method.

(2) The inclined section 277 need not have a plate shape, and may have any other shape or form as long as it has an inclined face that receives separated material and causes the received separated material to flow down. Further, the inclined section 277 is not limited to being supported in a cantilevered manner, and may alternatively be supported on both sides.

(3) The stay 278 that supports the image capture unit 247 is not limited to being supported in a cantilevered manner by the grain tank 212, and may alternatively be supported on both sides. The stay 278 may also be integrated with the inclined section 277.

(4) The inclined section 277 may also be made of a permeable member made of glass or resin. In this case, the image capture unit 247 may be located behind a lower part the inclined section 277, with the lens of the image capture unit 247 facing forward and upward from behind the inclined section 277. The image capture unit 247 captures an image of separated material flowing down on the upper face of the inclined section 277 through the permeable inclined section 277, from behind the inclined section 277.

Even if dust is flying in the grain tank 212, the image capture unit 247 is capable of capturing a clear image of separated material in a state where the dust is unlikely to affect the image capture, by capturing the image of the separated material from behind the inclined section 277.

(5) In the above embodiment, the inclined section 277 may also have a sensor for detecting separated material flowing on the upper face. The controller 282 receives a signal indicating that the sensor has detected separated material, and is capable of giving an image capture instruction to the image capture unit 247 in response to this signal. This configuration enables the image capture unit 247 to reliably captures images of separated material flowing down on the inclined section 277.

(6) The image capture unit 247 is not limited to being close to the inclined section 277, and may be located at any position as long as the image capture unit 247 is capable of capturing images of flowing separated material. For example, a configuration may be employed in which the grain tank 212 has a transparent window, and the image capture unit 247 is located outside the window to captures images through the window if the image capture unit 247 is capable of accurately capturing images of the upper face of the inclined section 277.

(7) In the above embodiment, captured images may be either still images or moving images. In the case of moving images, the number of frames of an image of separated product to be captured per unit time is greater than that in the case of still images, thus enabling more accurate detection of foreign matter.

(8) The inclination angle of the inclined section 277 may be uniform, or may gradually become obtuse or gradually become acute.

### Comparative Example

The following describes a comparative example of the above embodiment in which an inclined section and an image capture unit are located at intermediate positions (outside the grain tank 212) of the conveying path of the conveying apparatus (grain elevator 229 and grain releasing device 230A).

The grain elevator 229 extends to a position higher than an upper end of the grain tank 212, and has a slope (inclined section) that is inclined from near an upper end of the grain elevator 229 toward the grain tank 212. Separated material discharged from the grain elevator 229 slides down on the slope and is thereby guided to the grain tank 212. The image capture unit captures images of the separated material flowing down on the slope.

Separated material that is being conveyed before entering the grain tank 212 can thus be dispersed by the slope, and foreign matter can be distinguished with a simple configuration without providing an inclined section for image capture. Further, the image capture is unlikely to be affected by dust flying in the grain tank 212 since the inclined section 277 and the image capture unit 247 are not located within the grain tank 212.

Another comparative example may employ a configuration in which the feeding path (ascending path) of the grain elevator 229 has a first opening, the return path (descending path) of the grain elevator 229 has a second opening at a position lower than the first opening, an inclined tubular section (inclined section) connects the first opening to the second opening, and the image capture unit captures images of separated material flowing on a bottom of the tubular portion.

Although the above embodiment has described a combine, processing performed by the functional parts of the above embodiment may also be adopted as a grain separation method. In this case, the grain separation method includes: a reaping step of reaping planted grain culms in a field; a threshing step of threshing the reaped grain culms and separating the reaped grain culms into separated material containing normal grain and material to be discharged other than the separated material, with use of a threshing apparatus 201; a storing step of storing the separated material in a grain tank 212; a conveying step of conveying the separated material from the threshing apparatus 201 to the grain tank 212, with use of a conveying apparatus; an inclined section passage step of causing at least some of the separated material before being stored in the grain tank 212 to pass on a surface of an inclined section 277; an image capture step of capturing an image of the separated material passing through the inclined section 277, with use of an image capture unit 247; an image analysis step of analyzing the image captured by the image capture unit 247 and performing distinguishing processing for distinguishing normal grain in the separated material passing through the inclined section 277 from foreign matter other than the normal grain, the foreign matter being mixed in the separated material; and a grain releasing step of causing the conveying apparatus to throw the separated material into the grain tank 212, with use of a grain releasing device 230A, wherein in the inclined section passage step, the separated material thrown from the grain releasing device 230A is received within the grain tank 212.

Although the above embodiment has described a combine, processing performed by the functional parts of the above embodiment may also be adopted as a grain separation system. In this case, the grain separation system includes: a reaper 204 configured to reap planted grain culms in a field; a threshing apparatus 201 configured to thresh the reaped grain culms and separate the reaped grain culms into separated material containing normal grain and material to be discharged other than the separated material; a grain tank 212 in which the sorted grain is storable; a conveying apparatus configured to convey the separated material from the threshing apparatus 201 to the grain tank 212; an inclined section 277 having a surface on which at least some of the separated material before being stored in the grain tank 212 is passable; an image capture unit 247 configured to capture an image of the separated material passing through the inclined section 277; and an image analysis module 284 configured to analyze the image captured by the image capture unit 247 and perform distinguishing processing for distinguishing normal grain in the separated material passing through the inclined section 277 from foreign matter other than the normal grain, the foreign matter being mixed in the separated material, wherein the conveying apparatus includes a grain releasing device 230A configured to throw the separated material into the grain tank 212, and the inclined section 277 is located within the grain tank 212 in such a manner as to receive the separated material thrown from the grain releasing device 230A.

The functional parts of the above embodiment may also be adopted as a grain separation program. In this case, the grain separation program includes: a reaping function of reaping planted grain culms in a field; a threshing function of threshing the reaped grain culms and separating the reaped grain culms into separated material containing normal grain and material to be discharged other than the separated material, with use of a threshing apparatus 201; a storing function of storing the separated material in a grain tank 212; a conveying function of conveying the separated material from the threshing apparatus 201 to the grain tank 212, with use of a conveying apparatus; an inclined section passage function of causing at least some of the separated material before being stored in the grain tank 212 to pass on a surface of an inclined section 277; an image capture function of capturing an image of the separated material passing through the inclined section 277, with use of an image capture unit 247; an image analysis function of analyzing the image captured by the image capture unit 247 and performing distinguishing processing for distinguishing normal grain in the separated material passing through the inclined section 277 from foreign matter other than the normal grain, the foreign matter being mixed in the separated material; and a grain releasing function of causing the conveying apparatus to throw the separated material into the grain tank 212, with use of a grain releasing device 230A, wherein in the inclined section passage step, the separated material thrown from the grain releasing device 230A is received within the grain tank 212.

Further, this grain separation program may also be recorded in a recording medium.

### INDUSTRIAL APPLICABILITY

The present invention is applicable to not only normal combines but also head-feeding combines.

Further, the present invention is applicable to a combine that has a threshing unit for threshing reaped grain culms and a separation unit for separating grain in threshed material that is threshed by the threshing unit.

### DESCRIPTION OF REFERENCE SIGNS

### First Embodiment

1 Threshing apparatus
4 Reaper
12 Grain tank
29 Grain elevator (conveying apparatus)
29D Feeding path (conveying path)
29E Return path (conveying path)
30 Lateral-feed conveying device (conveying apparatus)
46 Temporary storage section
47 Image capture unit
71 Lid portion
72 Bottom portion
74 Motor (actuator)
75 Link
84 Image analysis module

### Second Embodiment

112 Grain tank
120 Combine
141 Threshing unit
142 Separation unit
170 Image capture unit
171 Distinguishing unit
172 Calculation unit
173 Parameter change unit
100G Captured image

### Third Embodiment

201 Threshing apparatus
204 Reaper
212 Grain tank
229 Grain elevator (conveying apparatus)
230 Lateral-feed conveying device (conveying apparatus)
230A Grain releasing device
247 Image capture unit
277 Inclined section
284 Image analysis module

1. A combine comprising:
a reaper configured to reap planted grain culms in a field;
a threshing apparatus configured to thresh the reaped grain culms and separate the reaped grain culms into separated material containing normal grain and material to be discharged other than the separated material;
a grain tank in which the separated material is storable;
a conveying apparatus configured to convey the separated material from the threshing apparatus to the grain tank;
a temporary storage section configured to take out and store some of the separated material that is being conveyed by the conveying apparatus;
an image capture unit configured to capture an image of the separated material stored in the temporary storage section; and
an image analysis module configured to analyze the image captured by the image capture unit and perform distinguishing processing for distinguishing the normal grain in the separated material stored in the temporary storage section from foreign matter other than the normal grain, the foreign matter being mixed in the separated material.

2. The combine according to claim 1,
wherein the separated material whose image has been captured by the image capture unit is returned to a conveying path of the conveying apparatus.

3. The combine according to claim 2,
wherein the conveying path includes a feeding path through which the separated material is conveyable and a return path in which the separated material is no longer conveyed, and
wherein the separated material whose image has been captured by the image capture unit is returned to the return path.

4. The combine according to claim 1,
wherein the temporary storage section has a lid portion that is openable and closable and constitutes an upper face of the temporary storage section, and a bottom portion that is openable and closable and constitutes a bottom face of the temporary storage section,
wherein the separated material is stored in the temporary storage section as a result of the lid portion being opened and the bottom portion being closed, and
wherein the separated material whose image has been captured by the image capture unit is discharged from the temporary storage section as a result of the bottom portion being opened.

5. The combine according to claim 4,
wherein the image capture unit captures an image of the separated material in an image capture-ready state where the lid portion is closed and the bottom portion is closed.

6. The combine according to claim 5, further comprising:
a link linked to the lid portion and the bottom portion such that the lid portion and the bottom portion move in conjunction with the link; and
an actuator configured to operate the link,
wherein the link being operated by the actuator switches the temporary storage section between a storing state where the lid portion is open and the bottom portion is closed such that the separated material is stored in the temporary storage section, and a discharging state where the lid portion is closed and the bottom portion is open such that the stored separated material is discharged, and
wherein the image capture-ready state emerges during transition from the storing state to the discharging state.

7. The combine according to claim 4,
wherein the lid portion partially constitutes a lower part of a conveying path of the conveying apparatus.

8. The combine according to claim 1,
wherein the combine has a neural network trained by machine learning, the neural network being stored in the combine, and
wherein the image analysis module performs the distinguishing processing by inputting the image captured by the image capture unit to the neural network.

9. The combine according to claim 8,
wherein the machine learning is performed by using, as input data, a plurality of the images captured by the image capture unit, and using, as training data, information indicating whether or not each of the plurality of images is an image of the foreign matter.

10. The combine according to claim 1,
wherein the foreign matter includes at least one of a foreign substance, damaged grain, dirty grain, a rachis branch, and bran.

11-14. (canceled)

15. A combine comprising:
a threshing unit configured to thresh reaped grain culms and discharge threshed material;
a separation unit configured to separate grain as separated material from the discharged threshed material;
a grain tank in which the separated material conveyed thereto is storable;
an image capture unit configured to acquire a captured image by capturing an image of an inside of a conveying path through which the separated material is conveyable from the separation unit to the grain tank; and
a distinguishing unit configured to distinguish, by means of image analysis, separated material included in the captured image into normal grain that meets a predetermined quality and foreign matter other than the normal grain, the foreign matter being mixed in the separated material.

16. The combine according to claim 15, further comprising:
a calculation unit configured to calculate a ratio between the normal grain and the foreign matter in the separated material included in the captured image, based on a result of the distinction by the distinguishing unit.

17. The combine according to claim 15, further comprising:
a parameter change unit configured to change a threshing parameter with which a threshing capability of the threshing unit is settable and a separation parameter with which a separation capability of the separation unit is settable, in accordance with the ratio between the normal grain and the foreign matter.

18. The combine according to claim 15,
wherein the distinguishing unit performs distinction by inputting image data generated based on the captured image, to a neural network trained to distinguish the normal grain in the separated material.

19. The combine according to claim 18,
wherein the neural network is trained to output a distinction result indicating that the separated material contains the normal grain if image data for training generated based on a captured image including the normal grain is input as training data, and is trained to output a distinction result indicating that the separated material contains the foreign matter if image data for training generated based on a captured image including the foreign matter is input as training data.

20-23. (canceled)

24. A combine comprising:
a reaper configured to reap planted grain culms in a field;
a threshing apparatus configured to thresh the reaped grain culms and separate the reaped grain culms into separated material containing normal grain and material to be discharged other than the separated material;
a grain tank in which the separated material is storable;
a conveying apparatus configured to convey the separated material from the threshing apparatus to the grain tank;
an inclined section having a surface on which at least some of the separated material before being stored in the grain tank is passable;
an image capture unit configured to capture an image of the separated material passing through the inclined section; and
an image analysis module configured to analyze the image captured by the image capture unit and perform distinguishing processing for distinguishing normal grain in the separated material passing through the inclined section from foreign matter other than the normal grain, the foreign matter being mixed in the separated material,
wherein the conveying apparatus includes a grain releasing device configured to throw the separated material into the grain tank, and
wherein the inclined section is located within the grain tank in such a manner as to receive the separated material thrown from the grain releasing device.

25. The combine according to claim 24,
wherein the image capture unit is located within the grain tank and faces the inclined section.

26. The combine according to claim 25,
wherein the image capture unit is located between the grain releasing device and the inclined section, with a back of the image capture unit facing the grain releasing device, and
wherein the grain releasing device throws the separated material such that the thrown separated material flies over the image capture unit and falls onto the inclined section.

27. The combine according to claim 24,
wherein the inclined section is made of a permeable material, and
wherein the image capture unit is located in a back-face region of the inclined section with respect to the surface thereof on which the separated material is passable.

28. The combine according to claim 24, further comprising:
a full sensor configured to come into contact with the separated material stored in the grain tank and detect that the grain tank is filled with the separated stored material, the full sensor being located in an upper part of an inside of the grain tank, and
wherein the inclined section and the image capture unit are located at positions higher than the full sensor.

29. The combine according to claim 24,
wherein the combine has a neural network trained by machine learning, the neural network being stored in the combine, and
wherein the image analysis module performs the distinguishing processing by inputting the image captured by the image capture unit to the neural network.

30. The combine according to claim 29,
wherein the machine learning is performed by using, as input data, a plurality of the images captured by the image capture unit, and using, as training data, information indicating whether or not each of the plurality of images is an image of the foreign matter.

31. The combine according to claim 24,
wherein the foreign matter includes at least one of a foreign substance, damaged grain, dirty grain, a rachis branch, and bran.

32-35. (canceled)
